(19) United States
(12) Patent Application Publication
(10) Pub. No.: US 2025/0324210 A1
(43) Pub. Date: Oct. 16, 2025

(54) VIRTUAL SPEAKER DETERMINING METHOD AND RELATED APPARATUS

(71) Applicant: HUAWEI TECHNOLOGIES CO., LTD., Shenzhen (CN)

(72) Inventors: Shuai LIU, Beijing (CN); Yuan GAO, Beijing (CN); Bingyin XIA, Beijing (CN); Zhe WANG, Beijing (CN)

(21) Appl. No.: 19/250,021

(22) Filed: Jun. 25, 2025

Related U.S. Application Data
(63) Continuation of application No. PCT/CN2023/133266, filed on Nov. 22, 2023.

(30) Foreign Application Priority Data
Dec. 29, 2022 (CN) 202211717964.9

(51) Int. Cl. H04S 7/00; H04S 3/00

(52) U.S. Cl. CPC H04S 7/30; H04S 3/008; H04S 2400/01; H04S 2400/11; H04S 2420/11

(57) ABSTRACT

This application discloses a virtual speaker determining method and a related apparatus. The method includes: obtaining attribute information of N first virtual speakers, obtaining attribute information of N second virtual speakers, and determining M target virtual speakers based on the attribute information of the N first virtual speakers and the attribute information of the N second virtual speakers. The target virtual speaker processes a target group of HOA signals, the second virtual speaker processes a reference group of HOA signals, and the first virtual speaker is a virtual speaker that the target group of HOA signals matches. The target virtual speaker is determined based on the attribute information of the second virtual speaker and the attribute information of the first virtual speaker, so that it can be ensured that attribute information of the target virtual speaker is not greatly different from the attribute information of the second virtual speaker.

### CROSS-REFERENCE TO RELATED APPLICATIONS

This application is a continuation of International Application No. PCT/CN2023/133266, filed on Nov. 22, 2023, which claims priority to Chinese Patent Application No. 202211717964.9, filed on Dec. 29, 2022. The disclosures of the aforementioned applications are hereby incorporated by reference in their entireties.

### TECHNICAL FIELD

This application relates to the field of three-dimensional audio encoding and decoding technologies, and in particular, to a virtual speaker determining method and a related apparatus.

### BACKGROUND

A three-dimensional audio technology is an audio technology for obtaining, processing, transmitting, rendering, and playing back sound events and three-dimensional sound field information in the real world through a computer, signal processing, or the like. The three-dimensional audio technology endows sound with a strong sense of space, encirclement, and immersion, to provide people with an auditory experience “as if they are really there”. Currently, a mainstream three-dimensional audio technology is a higher order ambisonics (HOA) audio technology. The HOA technology has a property of being independent of speaker layout in recording, encoding, and playback phases and a characteristic of rotatably playing back data in an HOA format, has higher flexibility during playback of an HOA signal, and therefore has attracted more attention.

In a process of encoding and decoding the HOA signal, a virtual speaker that matches an HOA coefficient of a current frame of HOA signal is selected from a virtual speaker set of a three-dimensional sound field based on the HOA coefficient of the current frame of HOA signal, and the matched virtual speaker is used as a target virtual speaker. In this way, the current frame of HOA signal is converted into a virtual speaker signal by using the target virtual speaker, to reduce a quantity of channels of the HOA signal, thereby improving encoding and decoding efficiency of the HOA signal.

However, positions of target virtual speakers corresponding to two adjacent frames of HOA signals in the three-dimensional sound field may be different, that is, there are differences between elevations and between azimuths of virtual speakers that the two adjacent frames of HOA signals respectively match. As a result, the two adjacent frames of HOA signals obtained through decoding sound spatially jumped. Therefore, how to adjust the virtual speakers that the two adjacent frames of HOA signals match becomes an urgent problem to be resolved currently.

### SUMMARY

This application provides a virtual speaker determining method and a related apparatus, to resolve a problem in a related technology that two adjacent frames of HOA signals obtained through decoding sound spatially jumped. The technical solutions are as follows.

According to a first aspect, a virtual speaker determining method is provided. The virtual speaker determining method may be applied to an encoder side device, or may be applied to a decoder side device. The method includes:

obtaining attribute information of N first virtual speakers, where the N first virtual speakers are virtual speakers that are in a virtual speaker set and that match an HOA coefficient of a target group of HOA signals, the target group of HOA signals includes at least one frame of HOA signal, and N is an integer greater than or equal to 1; obtaining attribute information of N second virtual speakers, where the N second virtual speakers are virtual speakers that are in the virtual speaker set and that are configured to process a reference group of HOA signals, and the reference group of HOA signals is at least one group of HOA signals before the target group of HOA signals; and determining M target virtual speakers based on the attribute information of the N first virtual speakers and the attribute information of the N second virtual speakers, where the M target virtual speakers are configured to process the target group of HOA signals, M is an integer greater than 1, and M is greater than N.

Because the target virtual speaker is configured to process the target group of HOA signals, the second virtual speaker is configured to process the reference group of HOA signals, and the first virtual speaker is a virtual speaker that the target group of HOA signals matches, after the first virtual speaker is determined, the target virtual speaker is determined based on the attribute information of the second virtual speaker and the attribute information of the first virtual speaker, to ensure that attribute information of the target virtual speaker is not greatly different from the attribute information of the second virtual speaker, thereby resolving a problem that two adjacent frames of HOA signals obtained through decoding sound spatially jumped.

For an example embodiment, at least one frame of HOA signal that needs to be encoded and decoded currently is used as the target group of HOA signals. The target group of HOA signals includes one frame of HOA signal, or the target group of HOA signals includes P frames of HOA signals, where P is an integer greater than 1.

The virtual speaker set can include a plurality of virtual speakers, and each virtual speaker in the plurality of virtual speakers has a corresponding HOA coefficient. N first virtual speakers that match an HOA coefficient of the at least one frame of HOA signal are selected from the virtual speaker set based on the HOA coefficient of the at least one frame of HOA signal and the HOA coefficient of each virtual speaker. Then, the attribute information of the N first virtual speakers is obtained based on identifiers of the N first virtual speakers from correspondences between the stored identifiers and the stored attribute information of the virtual speakers.

For an example embodiment, the reference group of HOA signals is one group of HOA signals before the target group of HOA signals. Alternatively, the reference group of HOA signals is a plurality of groups of HOA signals before the target group of HOA signals. In different cases, manners of obtaining the attribute information of the N second virtual speakers are different. The following separately describes the following two cases.

In a first case, the reference group of HOA signals can be one group of HOA signals before the target group of HOA signals. In this case, N virtual speakers that are configured to process this group of HOA signals are directly used as the N second virtual speakers, and the attribute information of the N second virtual speakers is obtained based on identifiers of the N second virtual speakers from correspondences between the stored identifiers and the stored attribute information of the virtual speakers.

In a second case, the reference group of HOA signals can be a plurality of groups of HOA signals before the target group of HOA signals.

Each group of HOA signals in the plurality of groups of HOA signals can correspond to N virtual speakers, and N virtual speakers corresponding to each group of HOA signals one-to-one correspond to N virtual speakers corresponding to another group of HOA signals. In this case, the virtual speakers that have the correspondences in the plurality of groups of HOA signals are used as a group of virtual speakers, to obtain N groups of virtual speakers. Any group of virtual speakers in the N groups of virtual speakers includes a virtual speaker corresponding to each group of HOA signals in the plurality of groups of HOA signals. Then, attribute information of a plurality of virtual speakers included in any group of virtual speakers in the N groups of virtual speakers is obtained from correspondences between the stored identifiers and the stored attribute information of the virtual speakers based on identifiers of the plurality of virtual speakers, to obtain one group of attribute information. In this way, for each group of virtual speakers in the N groups of virtual speakers, one group of attribute information can be determined according to the foregoing operations, to obtain N groups of attribute information. Finally, averaging is performed on a same group of attribute information in the N groups of attribute information, to obtain N pieces of attribute information, and the N pieces of attribute information are determined as the attribute information of the N second virtual speakers, to obtain the attribute information of the N second virtual speakers.

When the attribute information of the virtual speaker includes an elevation and an azimuth, the M target virtual speakers are determined according to the following operations (1) to (3).

(1) Determine, based on elevations and azimuths of the N first virtual speakers and elevations and azimuths of the N second virtual speakers, distances between the first virtual speakers and the second virtual speakers that have the correspondences, to obtain N distances.

(2) Determine M groups of elevations and azimuths based on the N distances.

Based on the foregoing descriptions, the target group of HOA signals includes one frame of HOA signal, or the target group of HOA signals includes P frames of HOA signals. In different cases, manners of determining the M groups of elevations and azimuths based on the N distances are different. The following separately describes the following two cases.

In a first case, the target group of HOA signals can include one frame of HOA signal, this frame of HOA signal can include H subframes, and H is an integer greater than 1. For each distance in the N distances, elevations and azimuths that respectively correspond to the H subframes included in this frame of HOA signal are determined based on the distance, to obtain H groups of elevations and azimuths, until each distance in the N distances is traversed, so as to obtain N*H=M groups of elevations and azimuths.

One distance in the N distances is used as a target distance, and elevations and azimuths that respectively correspond to the H subframes are determined according to the following operation, until each distance in the N distances is traversed: when the target distance is greater than a first distance threshold, determining, based on elevations and azimuths of a first virtual speaker and a second virtual speaker that correspond to the target distance, the elevations and the azimuths that respectively correspond to the H subframes.

For an example embodiment, an implementation process of determining, based on the elevations and the azimuths of the first virtual speaker and the second virtual speaker that correspond to the target distance, the elevations and the azimuths that respectively correspond to the H subframes includes: determining the elevation and the azimuth of the second virtual speaker that corresponds to the target distance as an elevation and an azimuth that correspond to a first subframe in the H subframes; determining the elevation and the azimuth of the first virtual speaker that corresponds to the target distance as an elevation and an azimuth that correspond to a last subframe in the H subframes; and for an i^{th} subframe in the H subframes, determining, through interpolation processing based on an elevation and an azimuth that correspond to an (i−1)th subframe in the H subframes and the elevation and the azimuth that correspond to the last subframe, an elevation and an azimuth that correspond to the i^{th} subframe, where i is greater than 0 and less than H−1.

That is, the elevation and the azimuth that correspond to the first subframe in the H subframes are an elevation and an azimuth of a target second virtual speaker of the reference group of HOA signals, and the elevation and the azimuth that correspond to the last subframe in the H subframes are an elevation and an azimuth of a target first virtual speaker of this frame of HOA signal. An elevation and an azimuth that correspond to any subframe other than the first subframe and the last subframe in the H subframes need to be obtained through interpolation processing based on an elevation and an azimuth of a previous subframe closest to the subframe and the elevation and the azimuth that correspond to the last subframe. In this way, when the target group of HOA signals includes one frame of HOA signal, interpolation processing is performed between the H subframes included in this frame of HOA signal, to implement smooth transition between the first virtual speaker and the second virtual speaker that correspond to the target distance.

For the i^{th} subframe in the H subframes, a start point of interpolation processing of the i^{th} subframe is the elevation and the azimuth that correspond to the (i−1)th subframe, and an end point of interpolation processing is the elevation and the azimuth that correspond to the last subframe. In other words, for any subframe other than the first subframe and the last subframe in the H subframes, a start point of interpolation processing of the subframe is always updated in real time. In this way, the elevations and the azimuths that respectively correspond to the H subframes can be determined more accurately.

It should be noted that, in actual application, there may be a case in which the target distance is not greater than the first distance threshold. In other words, a location of the target first virtual speaker of this frame of HOA signal is not greatly different from a location of the target second virtual speaker of the reference group of HOA signals. In an embodiment, the elevation and the azimuth of the first virtual speaker that corresponds to the target distance are determined as the elevations and the azimuths that respectively correspond to the H subframes. In other words, an elevation corresponding to each frame in the H subframes is equal to the elevation of the first virtual speaker that corresponds to the target distance, and an azimuth corresponding to each subframe is equal to the azimuth of the first virtual speaker that corresponds to the target distance.

In an embodiment, the elevation and the azimuth of the second virtual speaker that corresponds to the target distance are determined as elevations and azimuths that correspond to first K subframes in the H subframes, and the elevation and the azimuth of the first virtual speaker that corresponds to the target distance are determined as elevations and azimuths that correspond to remaining subframes in the H subframes, where K is an integer greater than or equal to 1, and K is less than H.

The first distance threshold can be preset. For example, the first distance threshold is 0.5. In addition, the first distance threshold may be adjusted based on different requirements.

In a second case, the target group of HOA signals can include P frames of HOA signals. For each distance in the N distances, elevations and azimuths that respectively correspond to the P frames of HOA signals are determined based on the distance, to obtain P groups of elevations and azimuths, until each distance in the N distances is traversed, so as to obtain N*P=M groups of elevations and azimuths.

One distance in the N distances is used as a target distance, and elevations and azimuths that respectively correspond to the P frames of HOA signals are determined, according to the following operation, until each distance in the N distances is traversed: when the target distance is greater than a second distance threshold, determining, based on elevations and azimuths of a first virtual speaker and a second virtual speaker that correspond to the target distance, the elevations and the azimuths that respectively correspond to the P frames of HOA signals.

For an example embodiment, an implementation process of determining, based on the elevations and the azimuths of the first virtual speaker and the second virtual speaker that correspond to the target distance, the elevations and the azimuths that respectively correspond to the P frames of HOA signals includes: determining the elevation and the azimuth of the second virtual speaker that corresponds to the target distance as an elevation and an azimuth that correspond to a first frame of HOA signal in the P frames of HOA signals; determining the elevation and the azimuth of the first virtual speaker that corresponds to the target distance as an elevation and an azimuth that correspond to a last frame of HOA signal in the P frames of HOA signals; and for a j^{th} frame of HOA signal in the P frames of HOA signals, determining, through interpolation processing based on an elevation and an azimuth that correspond to a (j−1)th frame of HOA signal in the P frames of HOA signals and the elevation and the azimuth that correspond to the last frame of HOA signal, an elevation and an azimuth that correspond to the j^{th} frame of HOA signal, where j is greater than 0 and less than P−1.

That is, the elevation and the azimuth that correspond to the first frame of HOA signal in the P frames of HOA signals are the elevation and the azimuth of the target second virtual speaker of the reference group of HOA signals, and the elevation and the azimuth that correspond to the last frame of HOA signal in the P frames of HOA signals are the elevation and the azimuth of the target first virtual speaker in the target group of HOA signals. An elevation and an azimuth that correspond to any frame of HOA signal other than the first frame of HOA signal and the last frame of HOA signal in the P frames of HOA signals need to be obtained through interpolation processing based on an elevation and an azimuth of a previous frame of HOA signal closest to this frame of HOA signal, and the elevation and azimuth that correspond to the last frame of HOA signal. In this way, when the target group of HOA signals includes the P frames of HOA signals, interpolation processing is performed between the P frames of HOA signals, to implement smooth transition between the first virtual speaker and the second virtual speaker that correspond to the target distance.

A start point of interpolation processing of the j^{th} frame of HOA signal in the P frames of HOA signals can be the elevation and the azimuth that correspond to the (j−1)th frame of HOA signal, and an end point of interpolation processing can be the elevation and the azimuth that correspond to the last frame of HOA signal. In other words, for any frame of HOA signal other than the first frame of HOA signal and the last frame of HOA signal in the P frames of HOA signals, a start point of interpolation processing of the frame of HOA signal is always updated in real time. In this way, the elevations and the azimuths that respectively correspond to the P frames of HOA signals can be determined more accurately.

It should be noted that, in actual application, there may be a case in which the target distance is not greater than the second distance threshold. In other words, a location of the target first virtual speaker of the target group of HOA signals is not greatly different from a location of the target second virtual speaker of the reference group of HOA signals. In an embodiment, the elevation and the azimuth of the first virtual speaker that corresponds to the target distance are determined as the elevations and the azimuths that respectively correspond to the P frames of HOA signals. In other words, an elevation corresponding to each frame of HOA signal in the P frames of HOA signals is equal to the elevation of the first virtual speaker that corresponds to the target distance, and an azimuth corresponding to each frame of HOA signal is equal to the azimuth of the first virtual speaker that corresponds to the target distance.

In an embodiment, the elevation and the azimuth of the second virtual speaker that corresponds to the target distance are determined as elevations and azimuths that correspond to first L frames of HOA signals in the P frames of HOA signals, and the elevation and the azimuth of the first virtual speaker that corresponds to the target distance are determined as elevations and azimuths that correspond to remaining frames of HOA signals in the P frames of HOA signals, where L is an integer greater than or equal to 1, and Lis less than P.

The second distance threshold can be preset, and the second distance threshold may be equal to or may not be equal to the first distance threshold. In addition, the second distance threshold may be adjusted based on different requirements.

(3) Determine virtual speakers that are in the virtual speaker set and that correspond to the M groups of elevations and azimuths as the M target virtual speakers.

After the M groups of elevations and azimuths are determined based on the N distances according to the foregoing operation (2), the virtual speakers that are in the virtual speaker set and that correspond to the M groups of elevations and azimuths can be determined as the M target virtual speakers, so that the M target virtual speakers subsequently process the target group of HOA signals.

Based on the foregoing descriptions, in actual application, the attribute information of the virtual speaker may further include other content, for example, the HOA coefficient of the virtual speaker. When the attribute information of the virtual speaker includes the HOA coefficient, the HOA coefficient of the virtual speaker needs to be first converted into the elevation and the azimuth of the virtual speaker according to a related algorithm, and then the M target virtual speakers are determined according to the foregoing operations (1) to (3).

In an embodiment, for the encoder side device, after determining the M target virtual speakers based on the attribute information of the N first virtual speakers and the attribute information of the N second virtual speakers, the encoder side device further needs to encode the attribute information of the M target virtual speakers into a bitstream. In this way, after receiving the bitstream, the decoder side device can parse the bitstream to obtain the attribute information of the M target virtual speakers, and reconstruct the target group of HOA signals based on the attribute information of the M target virtual speakers. Alternatively, the encoder side device directly encodes an index of a determining manner of the M target virtual speakers into a bitstream, so that after parsing the bitstream to obtain the index of the determining manner of the M target virtual speakers, the decoder side device determines the M target virtual speakers in real time based on the index.

According to a second aspect, a virtual speaker determining apparatus is provided. The virtual speaker determining apparatus has a function of implementing behavior of the virtual speaker determining method in the first aspect. The virtual speaker determining apparatus includes at least one module. The at least one module is configured to implement the virtual speaker determining method provided in the first aspect.

According to a third aspect, a computer device is provided. The computer device includes a processor and a memory, and the memory is configured to store a computer program for performing the virtual speaker determining method provided in the first aspect. The processor is configured to execute the computer program stored in the memory, to implement the virtual speaker determining method according to the first aspect.

In an embodiment, the computer device may further include a communication bus. The communication bus is configured to establish a connection between the processor and the memory. According to a fourth aspect, a computer-readable storage medium is provided. The storage medium stores instructions, and when the instructions are run on a computer, the computer is enabled to perform operations of the virtual speaker determining method according to the first aspect.

According to a fifth aspect, a computer program product including instructions is provided. When the instructions are run on a computer, the computer is enabled to perform operations of the virtual speaker determining method according to the first aspect. In other words, a computer program is provided. When the computer program is run on a computer, the computer is enabled to perform operations of the virtual speaker determining method according to the first aspect.

Technical effect obtained in the second aspect to the fifth aspect is similar to technical effect obtained by the corresponding technical means in the first aspect. Details are not described herein again.

### BRIEF DESCRIPTION OF DRAWINGS

FIG. 1 is a diagram of an implementation environment according to an embodiment of this application;

FIG. 2 is a diagram of an implementation environment of a terminal scenario according to an embodiment of this application;

FIG. 3 is a diagram of an implementation environment of a radio and television scenario according to an embodiment of this application;

FIG. 4 is a diagram of an implementation environment of a virtual reality streaming scenario according to an embodiment of this application;

FIG. 5 is a flowchart of a virtual speaker determining method according to an embodiment of this application;

FIG. 6 is a flowchart of another virtual speaker determining method according to an embodiment of this application;

FIG. 7 is a diagram of a structure of a virtual speaker determining apparatus according to an embodiment of this application; and

FIG. 8 is a diagram of a structure of a computer device according to an embodiment of this application.

### DESCRIPTION OF EMBODIMENTS

To make objectives, technical solutions, and advantages of embodiments of this application clearer, the following further describes implementations of this application in detail with reference to the accompanying drawings.

Before the virtual speaker determining method provided in embodiments of this application is described in detail, an implementation environment in embodiments of this application is first described.

In a process of encoding and decoding an HOA signal, an encoder side device selects, from a virtual speaker set based on an HOA coefficient of a current frame of HOA signal, a virtual speaker that matches the HOA coefficient of the current frame of HOA signal, uses the matched virtual speaker as a target virtual speaker, and further encodes attribute information of the target virtual speaker into a bitstream. In addition, the encoder side device further encodes a low-order component of the current frame of HOA signal into the bitstream. After receiving the bitstream, a decoder side device parses the bitstream to obtain the attribute information of the target virtual speaker and the low-order component of the current frame of HOA signal. Then, the decoder side device reconstructs the current frame of HOA signal based on the HOA coefficient of the target virtual speaker and the low-order component of the current frame of HOA signal. However, in actual application, there may be a case in which locations of target virtual speakers corresponding to two adjacent frames of HOA signals in a three-dimensional sound field differ greatly. As a result, the two adjacent frames of HOA signals reconstructed by the decoder side device sound spatially jumped. Therefore, an embodiment of this application provides a virtual speaker determining method. According to the method provided in this embodiment of this application, target virtual speakers corresponding to two adjacent frames of HOA signals can smoothly transit between the two frames of HOA signals, thereby resolving a problem that the two reconstructed adjacent frames of HOA signals sound spatially jumped.

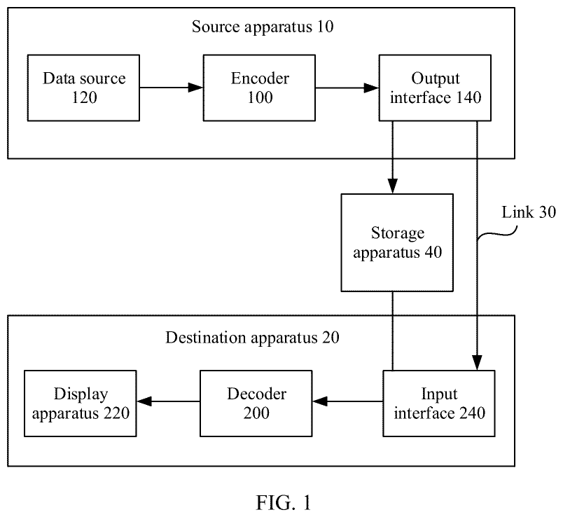

FIG. 1 is a diagram of an implementation environment according to an embodiment of this application. The implementation environment includes a source apparatus 10, a destination apparatus 20, a link 30, and a storage apparatus 40. The source apparatus 10 is configured to encode attribute information of a target virtual speaker and a low-order component of an HOA signal. Therefore, the source apparatus 10 may also be referred to as an encoder side device. The destination apparatus 20 is configured to parse a bitstream to obtain the attribute information of the target virtual speaker and the low-order component of the HOA signal. Therefore, the destination apparatus 20 may also be referred to as a decoder side device.

The link 30 may receive the bitstream generated by the source apparatus 10, and transmit the bitstream to the destination apparatus 20. The storage apparatus 40 may receive the bitstream generated by the source apparatus 10, and store the bitstream. In this case, the destination apparatus 20 can directly obtain the bitstream from the storage apparatus 40. Alternatively, the storage apparatus 40 corresponds to a file server or another intermediate storage apparatus that can store the bitstream generated by the source apparatus 10. In this case, the destination apparatus 20 may transmit in a streaming manner, or download the bitstream stored on the storage apparatus 40.

The source apparatus 10 and the destination apparatus 20 each include one or more processors and a memory coupled to the one or more processors. The memory includes a random access memory (RAM), a read-only memory (ROM), an electrically erasable programmable read-only memory (EEPROM), a flash memory, any other medium that can be used to store required program code in a form of instructions or data structures and that is accessible to a computer, or the like. For example, the source apparatus 10 and the destination apparatus 20 each include a desktop computer, a mobile computing apparatus, a notebook (for example, laptop) computer, a tablet computer, a set-top box, a handheld telephone set like a so-called “smartphone”, a television set, a camera, a display apparatus, a digital media player, a video game console, or a vehicle-mounted computer.

The link 30 includes one or more media or apparatuses that can transmit the bitstream from the source apparatus 10 to the destination apparatus 20. In an embodiment, the link 30 includes one or more communication media that can enable the source apparatus 10 to directly send the bitstream to the destination apparatus 20 in real time. In this embodiment of this application, the source apparatus 10 modulates the bitstream according to a communication standard, where the communication standard is a wireless communication protocol or the like, and sends the bitstream to the destination apparatus 20. The one or more communication media includes a wireless communication medium and/or a wired communication medium. For example, the one or more communication media includes a radio frequency (radio frequency, RF) spectrum or one or more physical transmission lines. The one or more communication media can be a part of a packet-based network. The packet-based network is a local area network, a wide area network, a global network (for example, the Internet), or the like. The one or more communication media includes a router, a switch, a base station, another device that facilitates communication from the source apparatus 10 to the destination apparatus 20, or the like. This is not specifically limited in embodiments of this application.

In an embodiment, the storage apparatus 40 is configured to store the received bitstream sent by the source apparatus 10, and the destination apparatus 20 can directly obtain the bitstream from the storage apparatus 40. In this case, the storage apparatus 40 includes any one of a plurality of distributed or locally accessed data storage media. For example, the any one of a plurality of distributed or locally accessed data storage media is a hard disk drive, a Blu-ray disc, a digital versatile disc (DVD), a compact disc read-only memory (CD-ROM), a flash memory, a volatile or non-volatile memory, or any other appropriate digital storage medium configured to store the bitstream.

In an embodiment, the storage apparatus 40 corresponds to a file server or another intermediate storage apparatus that can store the bitstream generated by the source apparatus 10, and the destination apparatus 20 may transmit in a streaming manner, or download the bitstream stored on the storage apparatus 40. The file server is any type of server that can store the bitstream and send the bitstream to the destination apparatus 20. In an embodiment, the file server includes a network server, a file transfer protocol (FTP) server, a network attached storage (NAS) apparatus, a local disk drive, or the like. The destination apparatus 20 can obtain the bitstream through any standard data connection (including an internet connection). The any standard data connection includes a wireless channel (for example, a Wi-Fi connection), a wired connection (for example, a digital subscriber line (DSL) or a cable modem), or a combination of a wireless channel and a wired connection suitable for obtaining the bitstream stored on the file server. Transmission of the bitstream from the storage apparatus 40 may be transmission in a streaming manner, transmission in a download manner, or a combination thereof.

The implementation environment shown in FIG. 1 is merely an embodiment. In addition, technologies in embodiments of this application are not only applicable to the source apparatus 10 that can encode the HOA signal and the destination apparatus 20 that decodes the bitstream in FIG. 1, but also applicable to another apparatus that can encode the HOA signal and decode the bitstream. This is not specifically limited in embodiments of this application.

In the implementation environment shown in FIG. 1, the source apparatus 10 includes a data source 120, an encoder 100, and an output interface 140. In some embodiments, the output interface 140 includes a modulator/demodulator (modem) and/or a sender. The sender is also referred to as a transmitter. The data source 120 includes an HOA signal capture apparatus, an archive including a previously captured HOA signal, a feed-in interface for receiving the HOA signal from an HOA signal content provider, and/or a computer graphics system for generating the HOA signal, or a combination of these sources of the HOA signal.

The data source 120 is configured to send the HOA signal to the encoder 100, and the encoder 100 is configured to encode the received HOA signal sent from the data source 120 to obtain the bitstream. The encoder sends the bitstream to the output interface. In some embodiments, the source apparatus 10 directly sends the bitstream to the destination apparatus 20 through the output interface 140. In another embodiment, the bitstream may alternatively be stored on the storage apparatus 40, so that the destination apparatus 20 subsequently obtains the bitstream for decoding and/or display.

In the implementation environment shown in FIG. 1, the destination apparatus 20 includes an input interface 240, a decoder 200, and a display apparatus 220. In some embodiments, the input interface 240 includes a receiver and/or a modem. The input interface 240 may receive the bitstream through the link 30 and/or from the storage apparatus 40, and then send the bitstream to the decoder 200. The decoder 200 may decode the received bitstream to obtain a reconstructed HOA signal. The decoder sends the reconstructed HOA signal to the display apparatus 220. The display apparatus 220 may be integrated with the destination apparatus 20 or disposed outside the destination apparatus 20. Generally, the display apparatus 220 displays the reconstructed HOA signal. The display apparatus 220 is a display apparatus of any one of a plurality of types. For example, the display apparatus 220 is a liquid crystal display (LCD), a plasma display, an organic light-emitting diode (OLED) display, or another type of display apparatus.

Although not shown in FIG. 1, in some aspects, the encoder 100 and the decoder 200 may be respectively integrated with an audio encoder and an audio decoder, and may include an appropriate multiplexer-demultiplexer (MUX-DEMUX) unit or other hardware and software for encoding both an audio and a video in a same data stream or separate data streams. In some embodiments, if applicable, the MUX-DEMUX unit may comply with the ITU H.223 multiplexer protocol or another protocol like the user datagram protocol (UDP).

The encoder 100 and the decoder 200 each may be any one of the following circuits: one or more microprocessors, a digital signal processor (DSP), an application-specific integrated circuit (ASIC), a field-programmable gate array (FPGA), discrete logic, hardware, or any combination thereof. If technologies in embodiments of this application are partially implemented in software, an apparatus may store instructions for the software in an appropriate non-volatile computer-readable storage medium, and may execute the instructions in hardware through one or more processors, to implement technologies in embodiments of this application. Any one of the foregoing content (including hardware, software, a combination of hardware and software, and the like) may be considered as one or more processors. Each of the encoder 100 and the decoder 200 may be included in one or more encoders or decoders. Either the encoder or the decoder can be integrated as a part of a combined encoder/decoder (codec) in a corresponding apparatus.

In embodiments of this application, the encoder 100 may be generally referred to as “signaling” or “sending” some information to another apparatus, for example, the decoder 200. The term “signaling” or “sending” may generally refer to transmission of syntax elements and/or other data used to decode the bitstream. Such transmission may occur in real time or almost in real time. Alternatively, such communication may occur after a period of time, for example, may occur when a syntax element in an encoded bitstream is stored in a computer-readable storage medium during encoding. The decoding apparatus may then retrieve the syntax element at any time after the syntax element is stored in the medium.

The virtual speaker determining method provided in this embodiment of this application may be applied to a plurality of scenarios. The following separately describes several of the scenarios.

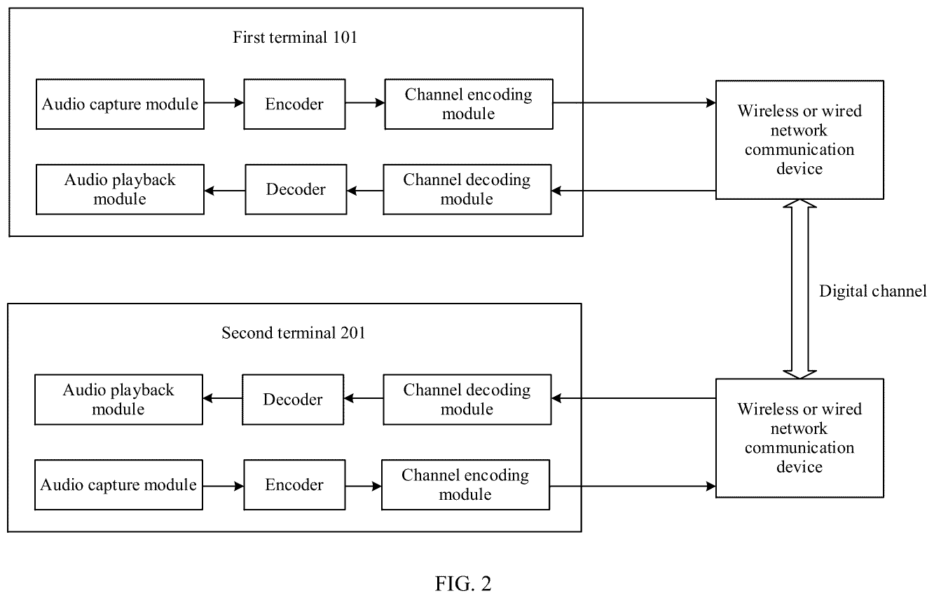

FIG. 2 is a diagram of an implementation environment in which a virtual speaker determining method is applied to a terminal scenario according to an embodiment of this application. The implementation environment includes a first terminal 101 and a second terminal 201. The first terminal 101 establishes a communication connection to the second terminal 201. The communication connection may be a wireless connection or a wired connection. This is not limited in embodiments of this application.

The first terminal 101 may be a transmit-end device or a receive-end device. Similarly, the second terminal 201 may be a receive-end device or a transmit-end device. When the first terminal 101 is a transmit-end device, the second terminal 201 is a receive-end device. When the first terminal 101 is a receive-end device, the second terminal 201 is a transmit-end device.

An example in which the first terminal 101 is a transmit-end device and the second terminal 201 is a receive-end device is used below for description.

The first terminal 101 may be the source apparatus 10 in the implementation environment shown in FIG. 1. The second terminal 201 may be the destination apparatus 20 in the implementation environment shown in FIG. 1. The first terminal 101 and the second terminal 201 each include an audio capture module, an audio playback module, an encoder, a decoder, a channel encoding module, and a channel decoding module.

The audio capture module in the first terminal 101 captures an HOA signal and transmits the HOA signal to the encoder. The encoder determines a target virtual speaker by using the virtual speaker determining method provided in this embodiment of this application. In addition, attribute information of the target virtual speaker and a low-order component of a current frame of HOA signal are encoded, and the encoding may be referred to as source encoding. Then, to transmit the HOA signal on a channel, the channel encoding module further needs to perform channel encoding, and then a bitstream obtained through encoding is transmitted in a digital channel through a wireless or wired network communication device.

The second terminal 201 receives, through the wireless or wired network communication device, the bitstream transmitted on the digital channel. The channel decoding module performs channel decoding on the bitstream, and then the decoder reconstructs the current frame of HOA signal based on an HOA coefficient of the target virtual speaker and the low-order component of the current frame of HOA signal, and then plays the HOA signal through the audio playback module.

The first terminal 101 and the second terminal 201 may be any electronic product that can perform human-computer interaction with a user through one or more of the following: a keyboard, a touchpad, a touchscreen, a remote control, a voice interaction device, a handwriting device, or the like, for example, a personal computer (PC), a mobile phone, a smartphone, a personal digital assistant (PDA), a wearable device, a pocket personal computer (pocket PC, PPC), a tablet computer, a smart automobile head unit, a smart television, or a smart speaker.

A person skilled in the art should understand that the foregoing terminals are merely examples. Other existing or possible future terminals to which embodiments of this application are applicable should also fall within the protection scope of embodiments of this application, and are included herein by reference.

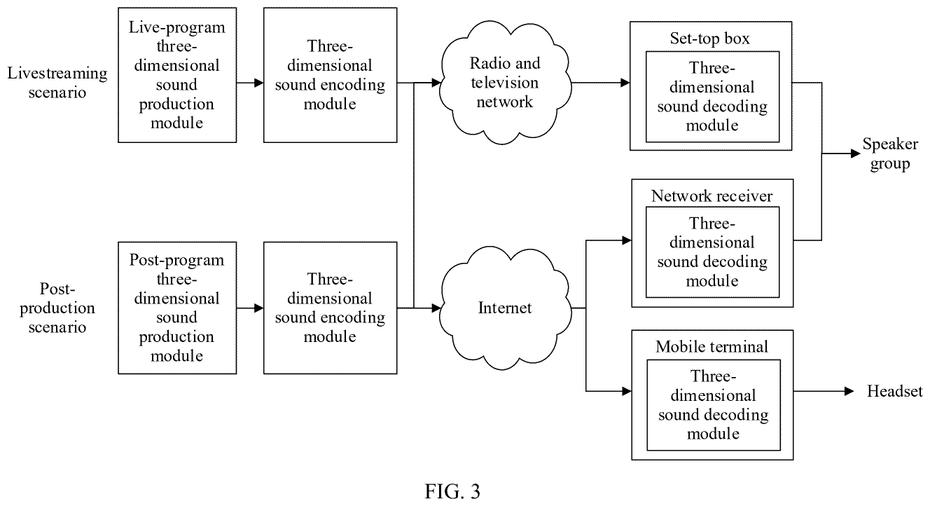

FIG. 3 is a diagram of an implementation environment in which a virtual speaker determining method is applied to a radio and television scenario according to an embodiment of this application. The radio and television scenario includes a livestreaming scenario and a post-production scenario. In the livestreaming scenario, the implementation environment includes a live-program three-dimensional sound production module, a three-dimensional sound encoding module, a set-top box, and a speaker group. The set-top box includes a three-dimensional sound decoding module. In the post-production scenario, the implementation environment includes a post-program three-dimensional sound production module, a three-dimensional sound encoding module, a network receiver, a mobile terminal, a headset, and the like.

In the livestreaming scenario, the live-program three-dimensional sound production module produces a three-dimensional sound signal. The three-dimensional sound signal includes an HOA signal. The three-dimensional sound signal is encoded by using an existing encoding method to obtain a bitstream. The bitstream is transmitted to a user side over a radio and television network, and is decoded by the three-dimensional sound decoder in the set-top box by using an existing decoding method, to reconstruct a three-dimensional sound signal. The speaker group plays the reconstructed three-dimensional sound signal. Alternatively, the bitstream is transmitted to the user side over the internet, and is decoded by a three-dimensional sound decoder in the network receiver by using an existing decoding method, to reconstruct a three-dimensional sound signal. The speaker group plays the reconstructed three-dimensional sound signal. Alternatively, the bitstream is transmitted to the user side over the internet, and is decoded by a three-dimensional sound decoder in the mobile terminal by using an existing decoding method, to reconstruct a three-dimensional sound signal. The headset plays the reconstructed three-dimensional sound signal.

In the post-production scenario, the post-program three-dimensional sound production module produces a three-dimensional sound signal. The three-dimensional sound signal is encoded by using an existing encoding method to obtain a bitstream. The bitstream is transmitted to a user side over a radio and television network, and is decoded by the three-dimensional sound decoder in the set-top box by using an existing decoding method, to reconstruct a three-dimensional sound signal. The speaker group plays the reconstructed three-dimensional sound signal. Alternatively, the bitstream is transmitted to the user side over the internet, and is decoded by a three-dimensional sound decoder in the network receiver by using an existing decoding method, to reconstruct a three-dimensional sound signal. The speaker group plays the reconstructed three-dimensional sound signal. Alternatively, the bitstream is transmitted to the user side over the internet, and is decoded by a three-dimensional sound decoder in the mobile terminal by using an existing decoding method, to reconstruct a three-dimensional sound signal. The headset plays the reconstructed three-dimensional sound signal.

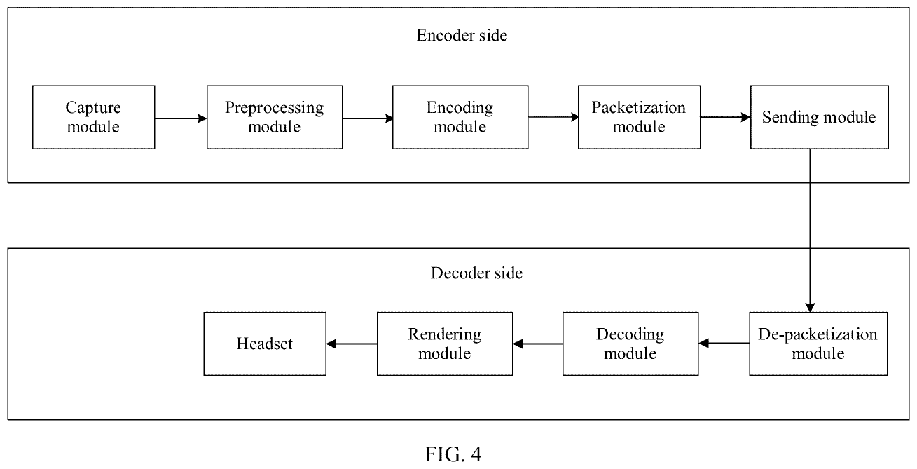

FIG. 4 is a diagram of an implementation environment in which a virtual speaker determining method is applied to a virtual reality stream scenario according to an embodiment of this application. The implementation environment includes an encoder side and a decoder side. The encoder side includes a capture module, a preprocessing module, an encoding module, a packetization module, and a sending module. The decoder side includes a de-packetization module, a decoding module, a rendering module, and a headset.

The capture module captures an HOA signal. Then, the preprocessing module performs a preprocessing operation. The preprocessing operation includes filtering out a low-frequency part from the signal usually by using 20 Hz or 50 Hz as a demarcation point, extracting orientation information from the signal, and the like. Then, the encoding module performs encoding by using an existing encoding method. After the encoding, the packetization module performs packetization. Then, the sending module sends a packetized signal to the decoder side.

The de-packetization module on the decoder side first performs de-packetization. Then, the decoding module performs decoding by using an existing decoding method. Then, the rendering module performs binaural rendering on a decoded signal. A rendered signal is mapped to a headset of a listener. The headset may be an independent headset, or may be a headset on a virtual reality-based glasses device.

It should be noted that the system architecture and the service scenario described in embodiments of this application are intended to describe the technical solutions in embodiments of this application more clearly, and do not constitute a limitation on the technical solutions provided in embodiments of this application. A person of ordinary skill in the art may know that: With the evolution of the system architecture and the emergence of new service scenarios, the technical solutions provided in embodiments of this application are also applicable to similar technical problems.

The following describes in detail the virtual speaker determining method provided in embodiments of this application. It should be noted that, with reference to the implementation environment shown in FIG. 1, the virtual speaker determining method may be performed by the encoder 100 in the source apparatus 10, or may be performed by the decoder 200 in the destination apparatus 20.

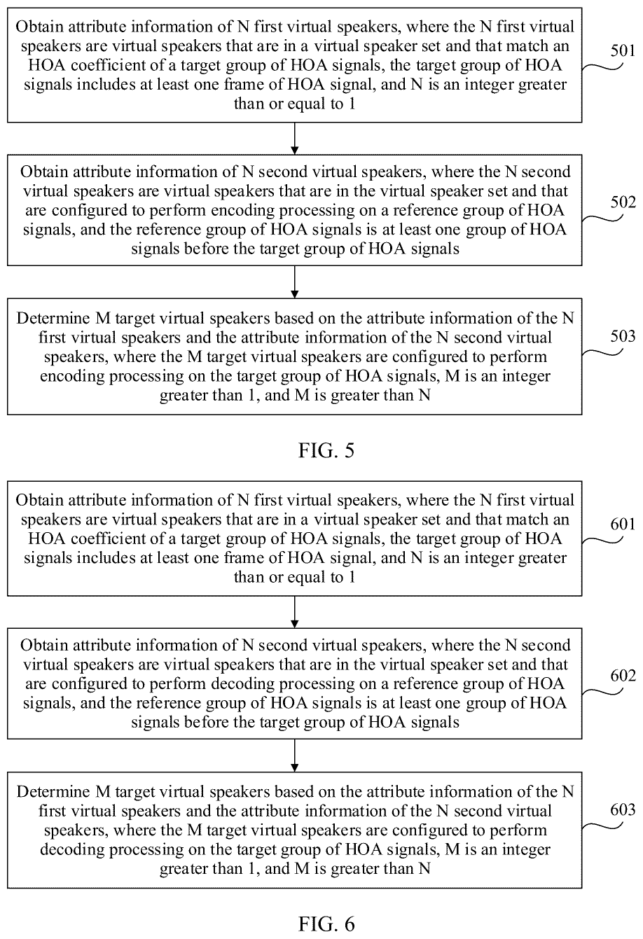

FIG. 5 is a flowchart of a virtual speaker determining method according to an embodiment of this application. The method is applied to an encoder side device. Refer to FIG. 5. The method includes the following operations.

Operation 501: Obtain attribute information of N first virtual speakers, where the N first virtual speakers are virtual speakers that are in a virtual speaker set and that match an HOA coefficient of a target group of HOA signals, the target group of HOA signals includes at least one frame of HOA signal, and N is an integer greater than or equal to 1.

In some embodiments, at least one frame of HOA signal that needs to be encoded currently is used as the target group of HOA signals. The target group of HOA signals includes one frame of HOA signal, or the target group of HOA signals includes P frames of HOA signals, where P is an integer greater than 1.

The virtual speaker set includes a plurality of virtual speakers, and each virtual speaker in the plurality of virtual speakers has a corresponding HOA coefficient. The encoder side device selects, from the virtual speaker set based on an HOA coefficient of the at least one frame of HOA signal and the HOA coefficient of each virtual speaker, N first virtual speakers that match the HOA coefficient of the at least one frame of HOA signal. Then, the encoder side device obtains the attribute information of the N first virtual speakers based on identifiers of the N first virtual speakers from correspondences between the stored identifiers and the stored attribute information of the virtual speakers.

When the target group of HOA signals includes one frame of HOA signal, the encoder side device separately performs an inner product operation on an HOA coefficient of this frame of HOA signal and the HOA coefficient of each virtual speaker to obtain a plurality of operation results. Any operation result in the plurality of operation results is a projection component of this frame of HOA signal on a corresponding virtual speaker. Then, the encoder side device sorts the plurality of operation results in descending order of projection components, and uses virtual speakers corresponding to first N operation results in the sorting results as the N first virtual speakers.

When the target group of HOA signals includes P frames of HOA signals, for each frame of HOA signals in the P frames of HOA signals, the encoder side device performs an inner product operation on an HOA coefficient of each frame of HOA signal and the HOA coefficient of each virtual speaker in sequence, to obtain a plurality of operation results. Any operation result in the plurality of operation results is a projection component of a specific frame of HOA signal in the P frames of HOA signals on a corresponding virtual speaker. Then, the encoder side device sorts the plurality of operation results in descending order of projection components, and uses virtual speakers corresponding to first N operation results in the sorting results as the N first virtual speakers.

It should be noted that, when the target group of HOA signals includes the P frames of HOA signals, for a specific frame of HOA signal in the P frames of HOA signals, the N first virtual speakers may not include a first virtual speaker that this frame of HOA signal matches. In other words, quantities of first virtual speakers that all of the P frames of HOA signals match are not equal, provided that the P frames of HOA signals match N first virtual speakers in total.

Certainly, in actual application, the encoder side device may further select the N first virtual speakers from the virtual speaker set according to another method. This is not limited in embodiments of this application.

The identifier of the virtual speaker uniquely identifies the virtual speaker, and the identifier may be a type, a number, a name, or the like of the virtual speaker, or may be obtained by combining the information. The attribute information of the virtual speaker includes an elevation and an azimuth. Certainly, in actual application, the attribute information of the virtual speaker may further include other content, for example, an HOA coefficient of the virtual speaker and an index of the virtual speaker. This is not limited in embodiments of this application.

In an embodiment, before selecting, from the virtual speaker set based on the HOA coefficient of the at least one frame of HOA signal and the HOA coefficient of each virtual speaker, the N first virtual speakers that match the HOA coefficient of the at least one frame of HOA signal, the encoder side device separately further needs to perform time-frequency transformation on the at least one frame of HOA signal. In other words, at least one frame of time-domain HOA signal is converted into a frequency-domain HOA signal to obtain a frequency-domain coefficient of the at least one frame of HOA signal, and then the frequency-domain coefficient of the at least one frame of HOA signal is determined as the HOA coefficient of the at least one frame of HOA signal.

Generally, a quantity of channels of the HOA signal is related to an order of the HOA signal. For example, if one frame of HOA signal is a Z-order signal, a quantity of channels of this frame of HOA signal is (Z+1)². The encoder side device selects the N first virtual speakers from the virtual speaker set according to the foregoing operations, so that a decoder side device subsequently converts, based on HOA coefficients of the N first virtual speakers, this frame of HOA signal whose quantity of channels is (Z+1)² into a virtual speaker signal whose quantity of channels is N.

Operation 502: Obtain attribute information of N second virtual speakers, where the N second virtual speakers are virtual speakers that are in the virtual speaker set and that are configured to perform encoding processing on a reference group of HOA signals, and the reference group of HOA signals is at least one group of HOA signals before the target group of HOA signals.

In actual application, for the encoder side device, the N second virtual speakers are configured to perform encoding processing on the reference group of HOA signals.

In some embodiments, the reference group of HOA signals is one group of HOA signals before the target group of HOA signals. Alternatively, the reference group of HOA signals is a plurality of groups of HOA signals before the target group of HOA signals. In different cases, manners in which the encoder side device obtains the attribute information of the N second virtual speakers are different. The following separately describes the following two cases.

In a first case, the reference group of HOA signals can be one group of HOA signals before the target group of HOA signals. In this case, the encoder side device directly uses N virtual speakers that are configured to perform encoding processing on this group of HOA signals as the N second virtual speakers, and obtains the attribute information of the N second virtual speakers based on identifiers of the N second virtual speakers from correspondences between the stored identifiers and the stored attribute information of the virtual speakers.

The N second virtual speakers configured to perform encoding processing on this group of HOA signals one-to-one correspond to the N first virtual speakers that the target group of HOA signals match. That is, for any group of HOA signals, N virtual speakers need to be selected from the virtual speaker set according to the method provided in this embodiment of this application, to obtain N virtual speakers configured to perform encoding processing on this group of HOA signals.

In a second case, the reference group of HOA signals can be a plurality of groups of HOA signals before the target group of HOA signals.

Each group of HOA signals in the plurality of groups of HOA signals corresponds to N virtual speakers, and N virtual speakers corresponding to each group of HOA signals one-to-one correspond to N virtual speakers corresponding to another group of HOA signals. In this case, the encoder side device uses the virtual speakers that have the correspondences in the plurality of groups of HOA signals as a group of virtual speakers, to obtain N groups of virtual speakers. Any group of virtual speakers in the N groups of virtual speakers includes a virtual speaker corresponding to each group of HOA signals in the plurality of groups of HOA signals. Then, attribute information of a plurality of virtual speakers included in any group of virtual speakers in the N groups of virtual speakers is obtained from correspondences between the stored identifiers and the stored attribute information of the virtual speakers based on identifiers of the plurality of virtual speakers, to obtain one group of attribute information. In this way, for each group of virtual speakers in the N groups of virtual speakers, one group of attribute information can be determined according to the foregoing operations, to obtain N groups of attribute information. Finally, averaging is performed on a same group of attribute information in the N groups of attribute information, to obtain N pieces of attribute information, and the N pieces of attribute information are determined as the attribute information of the N second virtual speakers, to obtain the attribute information of the N second virtual speakers.

For example, the reference group of HOA signals are three groups of HOA signals before the target group of HOA signals, and each group of HOA signals in the three groups of HOA signals corresponds to four virtual speakers, that is, N is 4. Four virtual speakers corresponding to a first group of HOA signals are a1, b1, c1, and d1, four virtual speakers corresponding to a second group of HOA signals are a2, b2, c2, and d2, and four virtual speakers corresponding to a third group of HOA signals are a3, b3, c3, and d3. The encoder side device uses the virtual speakers that have correspondences in the three groups of HOA signals as a group of virtual speakers, and obtained four groups of virtual speakers are [a1, a2, and a3], [b1, b2, and b3], [c1, c2, and c3], and [d1, d2, and d3]. Then, for each group of virtual speakers in the four groups of virtual speakers, the encoder side device performs averaging on attribute information of three virtual speakers in a same group to obtain four pieces of attribute information, and determines the four pieces of attribute information as attribute information of the four second virtual speakers.

Operation 503: Determine M target virtual speakers based on the attribute information of the N first virtual speakers and the attribute information of the N second virtual speakers, where the M target virtual speakers are configured to perform encoding processing on the target group of HOA signals, M is an integer greater than 1, and M is greater than N.

When the attribute information of the virtual speaker includes an elevation and an azimuth, the encoder side device determines the M target virtual speakers according to the following operations (1) to (3).

(1) Determine, based on elevations and azimuths of the N first virtual speakers and elevations and azimuths of the N second virtual speakers, distances between the first virtual speakers and the second virtual speakers that have the correspondences, to obtain N distances.

Based on the foregoing descriptions, the N first virtual speakers one-to-one correspond to the N second virtual speakers. For any first virtual speaker in the N first virtual speakers, manners of determining distances between the first virtual speakers and corresponding second virtual speakers are the same. Therefore, a first virtual speaker is selected from the N first virtual speakers as a target first virtual speaker. The following uses the target first virtual speaker as an example to describe determining a distance between the target first virtual speaker and a target second virtual speaker. There is a correspondence between the target second virtual speaker and the target first virtual speaker.

For example, the encoder side device determines the distance between the target first virtual speaker and the target second virtual speaker according to the following formula (1):

$${d}_{1} = arccos [ cos {β}_{11} cos {β}_{12} cos ( {\partial }_{11} - {\partial }_{12} ) + sin {β}_{11} sin {β}_{12} ] \qquad ( 1 )$$

In the foregoing formula (1), d, represents the distance between the target first virtual speaker and the target second virtual speaker, β₁₁ represents an azimuth of the target first virtual speaker, β₁₂ represents an azimuth of the target second virtual speaker, ∂₁₁ represents an elevation of the target first virtual speaker, and ∂₁₂, represents an elevation of the target second virtual speaker.

That is, for any first virtual speaker in the N first virtual speakers, a second virtual speaker corresponding to the first virtual speaker is selected from the N second virtual speakers, where the second virtual speaker and the first virtual speaker correspond to a same channel. Then, the distance between the first virtual speaker and the second virtual speaker is determined according to the foregoing formula (1) based on the elevation and the azimuth of the first virtual speaker and the elevation and the azimuth of the second virtual speaker, to obtain one distance. In this way, for each first virtual speaker in the N first virtual speakers, a second virtual speaker corresponding to the first virtual speaker can be determined according to the foregoing operations, and a distance between the first virtual speaker and the corresponding second virtual speaker is determined, to obtain the N distances.

(2) Determine M groups of elevations and azimuths based on the N distances.

Based on the foregoing descriptions, the target group of HOA signals includes one frame of HOA signal, or the target group of HOA signals includes P frames of HOA signals. In different cases, manners in which the encoder side device determines the M groups of elevations and azimuths based on the N distances are different. The following separately describes the following two cases.

In a first case, the target group of HOA signals can include one frame of HOA signal, this frame of HOA signal can include H subframes, and H is an integer greater than 1. For each distance in the N distances, elevations and azimuths that respectively correspond to the H subframes included in this frame of HOA signal are determined based on the distance, to obtain H groups of elevations and azimuths, until each distance in the N distances is traversed, so as to obtain N*H=M groups of elevations and azimuths.

One distance in the N distances is used as a target distance, and elevations and azimuths that respectively correspond to the H subframes are determined according to the following operation, until each distance in the N distances is traversed: when the target distance is greater than a first distance threshold, determining, based on elevations and azimuths of a first virtual speaker and a second virtual speaker that correspond to the target distance, the elevations and the azimuths that respectively correspond to the H subframes.

Based on the foregoing descriptions, the N distances are distances between the first virtual speakers and the second virtual speakers that have the correspondences. When the target distance is greater than the first distance threshold, it indicates that there is a large difference between a position of the target first virtual speaker of this frame of HOA signal and a position of the target second virtual speaker of the reference group of HOA signals. As a result, this frame of HOA signal and the reference group of HOA signals that are subsequently obtained through decoding sound spatially jumped. Therefore, the encoder side device needs to determine, based on the elevations and the azimuths of the first virtual speaker and the second virtual speaker that correspond to the target distance, the elevations and the azimuths that respectively correspond to the H subframes, so that smooth transition is performed between the first virtual speaker and the second virtual speaker that correspond to the target distance.

For example, an implementation process of determining, based on the elevations and the azimuths of the first virtual speaker and the second virtual speaker that correspond to the target distance, the elevations and the azimuths that respectively correspond to the H subframes includes: determining the elevation and the azimuth of the second virtual speaker that corresponds to the target distance as an elevation and an azimuth that correspond to a first subframe in the H subframes; determining the elevation and the azimuth of the first virtual speaker that corresponds to the target distance as an elevation and an azimuth that correspond to a last subframe in the H subframes; and for an i^{th} subframe in the H subframes, determining, through interpolation processing based on an elevation and an azimuth that correspond to an (i−1)th subframe in the H subframes and the elevation and the azimuth that correspond to the last subframe, an elevation and an azimuth that correspond to the i^{th} subframe, where i is greater than 0 and less than H−1.

It should be noted that i is a number of any subframe other than the first subframe and the last subframe in the H subframes. When the first subframe in the H subframes is numbered from 0, i is greater than 0 and less than H−1. When the first subframe in the H subframes is numbered from 1, i is greater than 1 and less than H. In other words, an elevation and an azimuth corresponding to any subframe other than the first subframe and the last subframe in the H subframes are determined through interpolation processing.

That is, the elevation and the azimuth that correspond to the first subframe in the H subframes are the elevation and the azimuth of the target second virtual speaker of the reference group of HOA signals, and the elevation and the azimuth that correspond to the last subframe in the H subframes are the elevation and the azimuth of the target first virtual speaker of this frame of HOA signal. The elevation and the azimuth that correspond to any subframe other than the first subframe and the last subframe in the H subframes need to be obtained through interpolation processing based on an elevation and an azimuth of a previous subframe closest to the subframe and the elevation and the azimuth that correspond to the last subframe. In this way, when the target group of HOA signals includes one frame of HOA signal, interpolation processing is performed between the H subframes included in this frame of HOA signal, to implement smooth transition between the first virtual speaker and the second virtual speaker that correspond to the target distance.

For the i^{th} subframe in the H subframes, a start point of interpolation processing of the i^{th} subframe is the elevation and the azimuth that correspond to the (i−1)th subframe, and an end point of interpolation processing is the elevation and the azimuth that correspond to the last subframe. In other words, for any subframe other than the first subframe and the last subframe in the H subframes, a start point of interpolation processing of the subframe is always updated in real time. In this way, the elevations and the azimuths that respectively correspond to the H subframes can be determined more accurately.

For example, the encoder side device determines, according to the following formula (2), the elevation and the azimuth that correspond to the i^{th} subframe.

$${\partial }_{i} = {\partial }_{i - 1} + \frac{{\partial }_{H} - {\partial }_{i - 1}}{{β}_{H} - {β}_{i - 1}} ( {β}_{i} - {β}_{i - 1} ) \qquad ( 2 )$$

In the foregoing formula (2), ∂ᵢ represents the elevation corresponding to the i^{th} subframe, ∂ᵢ₋₁ represents the elevation corresponding to the (i−1)th subframe, ∂_{H} represents the elevation corresponding to the last subframe, βᵢ represents the azimuth corresponding to the i^{th} subframe, βᵢ₋₁ represents the azimuth corresponding to the (i−1)th subframe, and β_{H} represents the azimuth corresponding to the last subframe.

It should be noted that, in the foregoing formula (2), the elevation and the azimuth that correspond to the i^{th} subframe are determined, by using a linear interpolation method, based on the elevation and the azimuth that correspond to the (i−1)th subframe and the elevation and the azimuth that correspond to the last subframe. Certainly, in actual application, the encoder side device can further determine, by using a non-linear interpolation method, the elevation and the azimuth that correspond to the i^{th} subframe, for example, a Lagrange interpolation method. This is not limited in embodiments of this application.

For example, this frame of HOA signal includes four subframes, the elevation of the first virtual speaker that corresponds to the target distance is ∂₁₁, and the azimuth is β₁₁; and the elevation of the second virtual speaker that corresponds to the target distance is ∂₁₂, and the azimuth is β₁₂. When the target distance is greater than the first distance threshold, an elevation corresponding to a first subframe is ∂₁₂, and an azimuth is β₁₂. An elevation corresponding to a fourth subframe is ∂₁₁, and an azimuth is β₁₁. An elevation corresponding to a second subframe is ∂₂, an azimuth is β₂, and the elevation ∂₂, and the azimuth β₂, are obtained through interpolation processing based on the elevation ∂₁₂, and the azimuth β₁₂ that correspond to the first subframe and the elevation ∂₁₁ and the azimuth β₁₁ that correspond to the fourth subframe. An elevation corresponding to a third subframe is ∂₃, an azimuth is β₃, and the elevation ∂₃, and the azimuth β₃ are obtained through interpolation processing based on the elevation ∂₂ and the azimuth β₂ that correspond to the second subframe and the elevation ∂₁₁ and the azimuth β₁₁ that correspond to the fourth subframe.

It should be noted that, in actual application, there may be a case in which the target distance is not greater than the first distance threshold. In other words, a location of the target first virtual speaker of this frame of HOA signal is not greatly different from a location of the target second virtual speaker of the reference group of HOA signals. In some embodiments, the encoder side device determines the elevation and the azimuth of the first virtual speaker that corresponds to the target distance as the elevations and the azimuths that respectively correspond to the H subframes. In other words, an elevation corresponding to each frame in the H subframes is equal to the elevation of the first virtual speaker that corresponds to the target distance, and an azimuth corresponding to each subframe is equal to the azimuth of the first virtual speaker that corresponds to the target distance.

In some other embodiments, the encoder side device determines the elevation and the azimuth of the second virtual speaker that corresponds to the target distance as elevations and azimuths that correspond to first K subframes in the H subframes, and determines the elevation and the azimuth of the first virtual speaker that corresponds to the target distance as elevations and azimuths that correspond to remaining subframes in the H subframes, where K is an integer greater than or equal to 1, and K is less than H.

For example, this frame of HOA signal includes four subframes, the elevation of the first virtual speaker that corresponds to the target distance is ∂₁₁, and the azimuth is β₁₁, and the elevation of the second virtual speaker that corresponds to the target distance is ∂₁₂, and the azimuth is β₁₂. When the target distance is not greater than the first distance threshold, an elevation corresponding to each subframe in the four subframes is ∂₁₁, and an azimuth is β₁₁. Alternatively, an elevation corresponding to a first subframe in the four subframes is ∂₁₂, and an azimuth is β₁₂, that is, K is 1, and an elevation corresponding to each subframe in remaining three subframes is ∂₁₁, and an azimuth is β₁₁.

The first distance threshold is preset. For example, the first distance threshold is 0.5. In addition, the first distance threshold may be adjusted based on different requirements.

In a second case, the target group of HOA signals can include P frames of HOA signals. For each distance in the N distances, elevations and azimuths that respectively correspond to the P frames of HOA signals are determined based on the distance, to obtain P groups of elevations and azimuths, until each distance in the N distances is traversed, so as to obtain N*P=M groups of elevations and azimuths.

One distance in the N distances is used as a target distance, and elevations and azimuths that respectively correspond to the P frames of HOA signals are determined, according to the following operation, until each distance in the N distances is traversed: when the target distance is greater than a second distance threshold, determining, based on elevations and azimuths of a first virtual speaker and a second virtual speaker that correspond to the target distance, the elevations and the azimuths that respectively correspond to the P frames of HOA signals.

Based on the foregoing descriptions, the N distances are distances between the first virtual speakers and the second virtual speakers that have the correspondences. When the target distance is greater than the second distance threshold, it indicates that there is a large difference between a position of the target first virtual speaker of the target group of HOA signals and a position of the target second virtual speaker of the reference group of HOA signals. As a result, the target group of HOA signals and the reference group of HOA signals that are subsequently obtained through decoding sound spatially jumped. Therefore, the encoder side device needs to determine, based on the elevations and the azimuths of the first virtual speaker and the second virtual speaker that correspond to the target distance, the elevations and the azimuths that respectively correspond to the P frames of HOA signals, so that smooth transition is performed between the first virtual speaker and the second virtual speaker that correspond to the target distance.

For example, an implementation process of determining, based on the elevations and the azimuths of the first virtual speaker and the second virtual speaker that correspond to the target distance, the elevations and the azimuths that respectively correspond to the P frames of HOA signals includes: determining the elevation and the azimuth of the second virtual speaker that corresponds to the target distance as an elevation and an azimuth that correspond to a first frame of HOA signal in the P frames of HOA signals; determining the elevation and the azimuth of the first virtual speaker that corresponds to the target distance as an elevation and an azimuth that correspond to a last frame of HOA signal in the P frames of HOA signals; and for a j^{th} frame of HOA signal in the P frames of HOA signals, determining, through interpolation processing based on an elevation and an azimuth that correspond to a (j−1)th frame of HOA signal in the P frames of HOA signals and the elevation and the azimuth that correspond to the last frame of HOA signal, an elevation and an azimuth that correspond to the j^{th} frame of HOA signal, where j is greater than 0 and less than P−1.

It should be noted that, j is a number of any frame of HOA signal other than the first frame HOA signal and the last frame HOA signal in the P frames of HOA signals. When the first frame HOA signal in the P frames of HOA signals is numbered from 0, j is greater than 0 and less than P−1. When the first frame HOA signal in the P frames of HOA signals is numbered from 1, j is greater than 1 and less than P. In other words, an elevation and an azimuth that correspond to any frame of HOA signal other than the first frame HOA signal and the last frame HOA signal in the P frames of HOA signals are determined through interpolation processing.

That is, the elevation and the azimuth that correspond to the first frame of HOA signal in the P frames of HOA signals are the elevation and the azimuth of the target second virtual speaker of the reference group of HOA signals, and the elevation and the azimuth that correspond to the last frame of HOA signal in the P frames of HOA signals are the elevation and the azimuth of the target first virtual speaker in the target group of HOA signals. The elevation and the azimuth that correspond to any frame of HOA signal other than the first frame of HOA signal and the last frame of HOA signal in the P frames of HOA signals need to be obtained through interpolation processing based on an elevation and an azimuth of a previous frame of HOA signal closest to this frame of HOA signal, and the elevation and azimuth that correspond to the last frame of HOA signal. In this way, when the target group of HOA signals includes the P frames of HOA signals, interpolation processing is performed between the P frames of HOA signals, to implement smooth transition between the first virtual speaker and the second virtual speaker that correspond to the target distance.

A start point of interpolation processing of the j^{th} frame of HOA signal in the P frames of HOA signals is the elevation and the azimuth that correspond to the (j−1)th frame of HOA signal, and an end point of interpolation processing is the elevation and the azimuth that correspond to the last frame of HOA signal. In other words, for any frame of HOA signal other than the first frame of HOA signal and the last frame of HOA signal in the P frames of HOA signals, a start point of interpolation processing of the frame of HOA signal is always updated in real time. In this way, the elevations and the azimuths that respectively correspond to the P frames of HOA signals can be determined more accurately.

It should be noted that, in actual application, there may be a case in which the target distance is not greater than the second distance threshold. In other words, a location of the target first virtual speaker of the target group of HOA signals is not greatly different from a location of the target second virtual speaker of the reference group of HOA signals. In some embodiments, the encoder side device determines the elevation and the azimuth of the first virtual speaker that corresponds to the target distance as the elevations and the azimuths that respectively correspond to the P frames of HOA signals. In other words, an elevation corresponding to each frame of HOA signal in the P frames of HOA signals is equal to the elevation of the first virtual speaker that corresponds to the target distance, and an azimuth corresponding to each frame of HOA signal is equal to the azimuth of the first virtual speaker that corresponds to the target distance.

In some other embodiments, the encoder side device determines the elevation and the azimuth of the second virtual speaker that corresponds to the target distance as elevations and azimuths that correspond to first L frames of HOA signals in the P frames of HOA signals, and determines the elevation and the azimuth of the first virtual speaker that corresponds to the target distance as elevations and azimuths that correspond to remaining frames of HOA signals in the P frames of HOA signals, where L is an integer greater than or equal to 1, and L is less than P.

The second distance threshold is preset, and the second distance threshold may be equal to or may not be equal to the first distance threshold. In addition, the second distance threshold may be adjusted based on different requirements.

(3) Determine virtual speakers that are in the virtual speaker set and that correspond to the M groups of elevations and azimuths as the M target virtual speakers.

After determining the M groups of elevations and azimuths based on the N distances according to the foregoing operation (2), the encoder side device determines the virtual speakers that are in the virtual speaker set and that correspond to the M groups of elevations and azimuths as the M target virtual speakers, so that the M target virtual speakers subsequently perform encoding processing on the target group of HOA signals.

Based on the foregoing descriptions, in actual application, the attribute information of the virtual speaker may further include other content, for example, the HOA coefficient of the virtual speaker. When the attribute information of the virtual speaker includes the HOA coefficient, the encoder side device needs to first convert the HOA coefficient of the virtual speaker into the elevation and the azimuth of the virtual speaker according to a related algorithm, and then determines the M target virtual speakers according to the foregoing operations (1) to (3).

In an embodiment, after determining the M target virtual speakers based on the attribute information of the N first virtual speakers and the attribute information of the N second virtual speakers, the encoder side device further needs to encode the attribute information of the M target virtual speakers into a bitstream. In this way, after receiving the bitstream, the decoder side device can parse the bitstream to obtain the attribute information of the M target virtual speakers, and reconstruct the target group of HOA signals based on the attribute information of the M target virtual speakers. Alternatively, the encoder side device directly encodes an index of a determining manner of the M target virtual speakers into a bitstream, so that after parsing the bitstream to obtain the index of the determining manner of the M target virtual speakers, the decoder side device determines the M target virtual speakers in real time based on the index.

In this embodiment of this application, because the target virtual speaker is configured to process the target group of HOA signals, the second virtual speaker is configured to process the reference group of HOA signals, and the first virtual speaker is a virtual speaker that the target group of HOA signals matches, after the first virtual speaker is determined, the target virtual speaker is determined based on the attribute information of the second virtual speaker and the attribute information of the first virtual speaker, to ensure that the attribute information of the target virtual speaker is not greatly different from the attribute information of the second virtual speaker, thereby resolving a problem that two adjacent frames of HOA signals obtained through decoding sound spatially jumped.

FIG. 6 is a flowchart of another virtual speaker determining method according to an embodiment of this application. The method is applied to a decoder side device. Refer to FIG. 6. The method includes the following operations.

Operation 601: Obtain attribute information of N first virtual speakers, where the N first virtual speakers are virtual speakers that are in a virtual speaker set and that match an HOA coefficient of a target group of HOA signals, the target group of HOA signals includes at least one frame of HOA signal, and N is an integer greater than or equal to 1.

In some embodiments, at least one frame of HOA signal that needs to be decoded currently is used as the target group of HOA signals. The target group of HOA signals includes one frame of HOA signal, or the target group of HOA signals includes P frames of HOA signals, where P is an integer greater than 1.

A process in which the decoder side device obtains the attribute information of the N first virtual speakers is similar to the process in which the encoder side device obtains the attribute information of the N first virtual speakers in the foregoing operation 501. Therefore, for details, refer to related content in the foregoing operation 501. Details are not described herein again.

In an embodiment, after obtaining the attribute information of the N first virtual speakers according to the foregoing operation 501, the encoder side device can further encode the attribute information of the N first virtual speakers into a bitstream. In this way, after receiving the bitstream, the decoder side device can directly parse the bitstream to obtain the attribute information of the N first virtual speakers.

The attribute information of the virtual speaker includes an elevation and an azimuth. Certainly, in actual application, the attribute information of the virtual speaker may further include other content, for example, an HOA coefficient of the virtual speaker and an index of the virtual speaker. This is not limited in embodiments of this application.

Operation 602: Obtain attribute information of N second virtual speakers, where the N second virtual speakers are virtual speakers that are in the virtual speaker set and that are configured to perform decoding processing on a reference group of HOA signals, and the reference group of HOA signals is at least one group of HOA signals before the target group of HOA signals.

For the decoder side device, the N second virtual speakers are configured to perform decoding processing on the reference group of HOA signals. A process in which the decoder side device obtains the attribute information of the N second virtual speakers is similar to the process in which the encoder side device obtains the attribute information of the N second virtual speakers in the foregoing operation 502. Therefore, for details, refer to related content in the foregoing operation 502. Details are not described herein again.

In an embodiment, after obtaining the attribute information of the N second virtual speakers according to the foregoing operation 502, the encoder side device can further encode the attribute information of the N second virtual speakers into a bitstream. In this way, after receiving the bitstream, the decoder side device can directly parse the bitstream to obtain the attribute information of the N second virtual speakers.

Operation 603: Determine M target virtual speakers based on the attribute information of the N first virtual speakers and the attribute information of the N second virtual speakers, where the M target virtual speakers are configured to perform decoding processing on the target group of HOA signals, M is an integer greater than 1, and M is greater than N.

In some embodiments, after determining the M target virtual speakers based on the attribute information of the N first virtual speakers and the attribute information of the N second virtual speakers, the encoder side device further encodes an index of a determining manner of the M target virtual speakers into a bitstream. Therefore, after receiving the bitstream, the decoder side device can parse the bitstream to obtain the index of the determining manner of the M target virtual speakers, and then determine the M target virtual speakers based on the attribute information of the N first virtual speakers and the attribute information of the N second virtual speakers in the determining manner indicated by the index.

In some other embodiments, when the attribute information of the virtual speaker includes an elevation and an azimuth, the decoder side device determines the M target virtual speakers according to the following operations (1) to (3).

(1) Determine, based on elevations and azimuths of the N first virtual speakers and elevations and azimuths of the N second virtual speakers, distances between the first virtual speakers and the second virtual speakers that have the correspondences, to obtain N distances.

A process in which the decoder side device determines the N distances based on the elevations and the azimuths of the N first virtual speakers and the elevations and the azimuths of the N second virtual speakers is similar to the process in which the encoder side device determines the N distances based on the elevations and the azimuths of the N first virtual speakers and the elevations and the azimuths of the N second virtual speakers in the foregoing operation 503. Therefore, for details, refer to related content in the foregoing operation 503. Details are not described herein again.

(2) Determine M groups of elevations and azimuths based on the N distances.

Based on the foregoing descriptions, the target group of HOA signals can include one frame of HOA signal, or the target group of HOA signals can include P frames of HOA signals. In different cases, manners in which the decoder side device determines the M groups of elevations and azimuths based on the N distances are different. The following separately describes the following two cases.

In a first case, the target group of HOA signals can include one frame of HOA signal, this frame of HOA signal can include H subframes, and H is an integer greater than 1. For each distance in the N distances, elevations and azimuths that respectively correspond to the H subframes included in this frame of HOA signal are determined based on the distance, to obtain H groups of elevations and azimuths, until each distance in the N distances is traversed, so as to obtain N*H=M groups of elevations and azimuths.

One distance in the N distances is used as a target distance, and elevations and azimuths that respectively correspond to the H subframes are determined according to the following operation, until each distance in the N distances is traversed: when the target distance is greater than a first distance threshold, determining, based on elevations and azimuths of a first virtual speaker and a second virtual speaker that correspond to the target distance, the elevations and the azimuths that respectively correspond to the H subframes.

For an example embodiment, an implementation process of determining, based on the elevations and the azimuths of the first virtual speaker and the second virtual speaker that correspond to the target distance, the elevations and the azimuths that respectively correspond to the H subframes includes: determining the elevation and the azimuth of the second virtual speaker that corresponds to the target distance as an elevation and an azimuth that correspond to a first subframe in the H subframes; determining the elevation and the azimuth of the first virtual speaker that corresponds to the target distance as an elevation and an azimuth that correspond to a last subframe in the H subframes; and for an i^{th} subframe in the H subframes, determining, through interpolation processing based on an elevation and an azimuth that correspond to an (i−1)th subframe in the H subframes and the elevation and the azimuth that correspond to the last subframe, an elevation and an azimuth that correspond to the i^{th} subframe, where i is greater than 0 and less than H−1.

It should be noted that, in actual application, there may be a case in which the target distance is not greater than the first distance threshold. In other words, a location of the target first virtual speaker of this frame of HOA signal is not greatly different from a location of the target second virtual speaker of the reference group of HOA signals. In some embodiments, the decoder side device determines the elevation and the azimuth of the first virtual speaker that corresponds to the target distance as the elevations and the azimuths that respectively correspond to the H subframes. In other words, an elevation corresponding to each frame in the H subframes is equal to the elevation of the first virtual speaker that corresponds to the target distance, and an azimuth corresponding to each subframe is equal to the azimuth of the first virtual speaker that corresponds to the target distance.

In some other embodiments, the decoder side device determines the elevation and the azimuth of the second virtual speaker that corresponds to the target distance as elevations and azimuths that correspond to first K subframes in the H subframes, and determines the elevation and the azimuth of the first virtual speaker that corresponds to the target distance as elevations and azimuths that correspond to remaining subframes in the H subframes, where K is an integer greater than or equal to 1, and K is less than H.

The first distance threshold is preset. For example, the first distance threshold is 0.5. In addition, the first distance threshold may be adjusted based on different requirements.

In a second case, the target group of HOA signals can include P frames of HOA signals. For each distance in the N distances, elevations and azimuths that respectively correspond to the P frames of HOA signals are determined based on the distance, to obtain P groups of elevations and azimuths, until each distance in the N distances is traversed, so as to obtain N*P=M groups of elevations and azimuths.

One distance in the N distances is used as a target distance, and elevations and azimuths that respectively correspond to the P frames of HOA signals are determined, according to the following operation, until each distance in the N distances is traversed: when the target distance is greater than a second distance threshold, determining, based on elevations and azimuths of a first virtual speaker and a second virtual speaker that correspond to the target distance, the elevations and the azimuths that respectively correspond to the P frames of HOA signals.

For example, an implementation process of determining, based on the elevations and the azimuths of the first virtual speaker and the second virtual speaker that correspond to the target distance, the elevations and the azimuths that respectively correspond to the P frames of HOA signals can include: determining the elevation and the azimuth of the second virtual speaker that corresponds to the target distance as an elevation and an azimuth that correspond to a first frame of HOA signal in the P frames of HOA signals; determining the elevation and the azimuth of the first virtual speaker that corresponds to the target distance as an elevation and an azimuth that correspond to a last frame of HOA signal in the P frames of HOA signals; and for a j^{th} frame of HOA signal in the P frames of HOA signals, determining, through interpolation processing based on an elevation and an azimuth that correspond to a (j−1)th frame of HOA signal in the P frames of HOA signals and the elevation and the azimuth that correspond to the last frame of HOA signal, an elevation and an azimuth that correspond to the j^{th} frame of HOA signal, where j is greater than 0 and less than P−1.

It should be noted that, in actual application, there may be a case in which the target distance is not greater than the second distance threshold. In other words, a location of the target first virtual speaker of the target group of HOA signals is not greatly different from a location of the target second virtual speaker of the reference group of HOA signals. In some embodiments, the decoder side device determines the elevation and the azimuth of the first virtual speaker that corresponds to the target distance as the elevations and the azimuths that respectively correspond to the P frames of HOA signals. In other words, an elevation corresponding to each frame of HOA signal in the P frames of HOA signals is equal to the elevation of the first virtual speaker that corresponds to the target distance, and an azimuth corresponding to each frame of HOA signal is equal to the azimuth of the first virtual speaker that corresponds to the target distance.

In some other embodiments, the decoder side device determines the elevation and the azimuth of the second virtual speaker that corresponds to the target distance as elevations and azimuths that correspond to first L frames of HOA signals in the P frames of HOA signals, and determines the elevation and the azimuth of the first virtual speaker that corresponds to the target distance as elevations and azimuths that correspond to remaining frames of HOA signals in the P frames of HOA signals, where L is an integer greater than or equal to 1, and L is less than P.

The second distance threshold is preset, and the second distance threshold may be equal to or may not be equal to the first distance threshold. In addition, the second distance threshold may be adjusted based on different requirements.

(3) Determine virtual speakers that are in the virtual speaker set and that correspond to the M groups of elevations and azimuths as the M target virtual speakers.

After determining the M groups of elevations and azimuths based on the N distances according to the foregoing operation (2), the decoder side device determines the virtual speakers that are in the virtual speaker set and that correspond to the M groups of elevations and azimuths as the M target virtual speakers, so that the M target virtual speakers subsequently perform decoding processing on the target group of HOA signals.

Based on the foregoing descriptions, in actual application, the attribute information of the virtual speaker may further include other content, for example, the HOA coefficient of the virtual speaker. When the attribute information of the virtual speaker includes the HOA coefficient, the decoder side device needs to first convert the HOA coefficient of the virtual speaker into the elevation and the azimuth of the virtual speaker according to a related algorithm, and then determines the M target virtual speakers according to the foregoing operations (1) to (3).

It should be noted that the foregoing content is described by using an example in which the decoder side device determines the M target virtual speakers in real time. In actual application, after determining the M target virtual speakers based on the attribute information of the N first virtual speakers and the attribute information of the N second virtual speakers, the encoder side device further encodes the attribute information of the M target virtual speakers into a bitstream. In this way, after receiving the bitstream, the decoder side device can directly parse the bitstream to obtain the attribute information of the M target virtual speakers, and reconstruct the target group of HOA signals based on the attribute information of the M target virtual speakers, without determining the M target virtual speakers.

In this embodiment of this application, because the target virtual speaker is configured to process the target group of HOA signals, the second virtual speaker is configured to process the reference group of HOA signals, and the first virtual speaker is a virtual speaker that the target group of HOA signals matches, after the first virtual speaker is determined, the target virtual speaker is determined based on the attribute information of the second virtual speaker and the attribute information of the first virtual speaker, to ensure that the attribute information of the target virtual speaker is not greatly different from the attribute information of the second virtual speaker, thereby resolving a problem that two adjacent frames of HOA signals obtained through decoding sound spatially jumped.

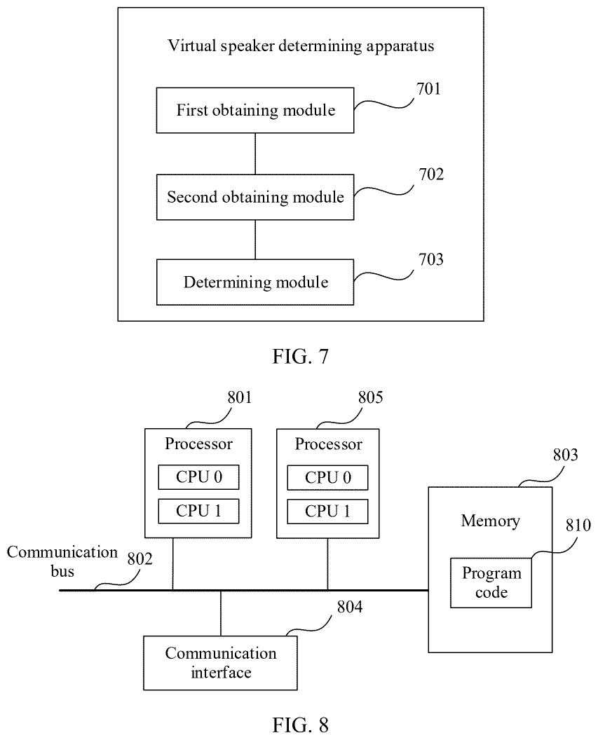

FIG. 7 is a diagram of a structure of a virtual speaker determining apparatus according to an embodiment of this application. The virtual speaker determining apparatus may be implemented as a part or all of a computer device by using software, hardware, or a combination thereof. The computer device may be the encoder side device or the decoder side device mentioned above. Refer to FIG. 7. The apparatus includes a first obtaining module 701, a second obtaining module 702, and a determining module 703.

The first obtaining module 701 is configured to obtain attribute information of N first virtual speakers, where the N first virtual speakers are virtual speakers that are in a virtual speaker set and that match an HOA coefficient of a target group of HOA signals, the target group of HOA signals includes at least one frame of HOA signal, and N is an integer greater than or equal to 1. For a detailed implementation process, refer to corresponding content in the foregoing embodiments. Details are not described herein again.

The second obtaining module 702 is configured to obtain attribute information of N second virtual speakers, where the N second virtual speakers are virtual speakers that are in the virtual speaker set and that are configured to process a reference group of HOA signals, and the reference group of HOA signals is at least one group of HOA signals before the target group of HOA signals. For a detailed implementation process, refer to corresponding content in the foregoing embodiments. Details are not described herein again.

The determining module 703 is configured to determine M target virtual speakers based on the attribute information of the N first virtual speakers and the attribute information of the N second virtual speakers, where the M target virtual speakers are configured to process the target group of HOA signals, M is an integer greater than 1, and M is greater than N. For a detailed implementation process, refer to corresponding content in the foregoing embodiments. Details are not described herein again.

In an embodiment, the attribute information includes an elevation and an azimuth, and the N first virtual speakers one-to-one correspond to the N second virtual speakers.

The determining module 703 includes:
a first determining unit, configured to determine, based on elevations and azimuths of the N first virtual speakers and elevations and azimuths of the N second virtual speakers, distances between the first virtual speakers and the second virtual speakers that have the correspondences, to obtain N distances;
a second determining unit, configured to determine M groups of elevations and azimuths based on the N distances; and
a third determining unit, configured to determine virtual speakers that are in the virtual speaker set and that correspond to the M groups of elevations and azimuths as the M target virtual speakers.

In an embodiment, the target group of HOA signals includes one frame of HOA signal, the one frame of HOA signal includes H subframes, H is an integer greater than 1, and M is a product of H and N.

The second determining unit is specifically configured to:
use one distance in the N distances as a target distance, and determine, according to the following operation, elevations and azimuths that respectively correspond to the H subframes, until each distance in the N distances is traversed:
when the target distance is greater than a first distance threshold, determining, based on elevations and azimuths of a first virtual speaker and a second virtual speaker that correspond to the target distance, the elevations and the azimuths that respectively correspond to the H subframes.

In an embodiment, the second determining unit is specifically configured to:
determine the elevation and the azimuth of the second virtual speaker that corresponds to the target distance as an elevation and an azimuth that correspond to a first subframe in the H subframes;
determine the elevation and the azimuth of the first virtual speaker that corresponds to the target distance as an elevation and an azimuth that correspond to a last subframe in the H subframes; and
for an i^{th} subframe in the H subframes, determine, through interpolation processing based on an elevation and an azimuth that correspond to an (i−1)th subframe in the H subframes and the elevation and the azimuth that correspond to the last subframe, an elevation and an azimuth that correspond to the i^{th} subframe, where i is greater than 0 and less than H−1.

In an embodiment, the second determining unit is further specifically configured to:
when the target distance is not greater than the first distance threshold, determine the elevation and the azimuth of the first virtual speaker that corresponds to the target distance as the elevations and the azimuths that respectively correspond to the H subframes; or
when the target distance is not greater than the first distance threshold, determine the elevation and the azimuth of the second virtual speaker that corresponds to the target distance as elevations and azimuths that correspond to first K subframes in the H subframes, and determine the elevation and the azimuth of the first virtual speaker that corresponds to the target distance as elevations and azimuths that correspond to remaining subframes in the H subframes, where K is an integer greater than or equal to 1, and K is less than H.

In an embodiment, the target group of HOA signals includes P frames of HOA signals, P is an integer greater than 1, and M is a product of P and N.

The second determining unit is specifically configured to:
use one distance in the N distances as a target distance, and determine, according to the following operation, elevations and azimuths that respectively correspond to the P frames of HOA signals, until each distance in the N distances is traversed:
when the target distance is greater than a second distance threshold, determining, based on elevations and azimuths of a first virtual speaker and a second virtual speaker that correspond to the target distance, the elevations and the azimuths that respectively correspond to the P frames of HOA signals.

In an embodiment, the second determining unit is specifically configured to:
determine the elevation and the azimuth of the second virtual speaker that corresponds to the target distance as an elevation and an azimuth that correspond to a first frame of HOA signal in the P frames of HOA signals;
determine the elevation and the azimuth of the first virtual speaker that corresponds to the target distance as an elevation and an azimuth that correspond to a last frame of HOA signal in the P frames of HOA signals; and
for a i^{th} frame of HOA signal in the P frames of HOA signals, determine, through interpolation processing based on an elevation and an azimuth that correspond to a (j−1)th frame of HOA signal in the P frames of HOA signals and the elevation and the azimuth that correspond to the last frame of HOA signal, an elevation and an azimuth that correspond to the j^{th} frame of HOA signal, where j is greater than 0 and less than P−1.

In an embodiment, the second determining unit is further specifically configured to:
when the target distance is not greater than the second distance threshold, determine the elevation and the azimuth of the first virtual speaker that corresponds to the target distance as the elevations and the azimuths that respectively correspond to the P frames of HOA signals; or
when the target distance is not greater than the second distance threshold, determine the elevation and the azimuth of the second virtual speaker that corresponds to the target distance as elevations and azimuths that correspond to first L frames of HOA signals in the P frames of HOA signals, and determine the elevation and the azimuth of the first virtual speaker that corresponds to the target distance as elevations and azimuths that correspond to remaining frames of HOA signals in the P frames of HOA signals, where L is an integer greater than or equal to 1, and L is less than P.

In an embodiment, the apparatus is applied to an encoder side device.

The apparatus further includes:
a first encoding module, configured to encode attribute information of the M target virtual speakers into a bitstream; or
a second encoding module, configured to encode an index of a determining manner of the M target virtual speakers into a bitstream.

In this embodiment of this application, because the target virtual speaker is configured to process the target group of HOA signals, the second virtual speaker is configured to process the reference group of HOA signals, and the first virtual speaker is a virtual speaker that the target group of HOA signals matches, after the first virtual speaker is determined, the target virtual speaker is determined based on the attribute information of the second virtual speaker and the attribute information of the first virtual speaker, to ensure that the attribute information of the target virtual speaker is not greatly different from the attribute information of the second virtual speaker, thereby resolving a problem that two adjacent frames of HOA signals obtained through decoding sound spatially jumped.

It needs to be noted that, when the virtual speaker determining apparatus provided in the foregoing embodiment determines the virtual speaker, the division of the foregoing function modules is merely used as an example for description. In actual application, the foregoing functions may be allocated to and completed by different function modules, that is, an internal structure of the apparatus is divided into different function modules to complete all or a part of the functions described above. In addition, the virtual speaker determining apparatus provided in the foregoing embodiment pertains to a same concept as the virtual speaker determining method embodiments. For a specific implementation process, refer to the method embodiments. Details are not described herein again.

FIG. 8 is a diagram of a structure of a computer device according to an embodiment of this application. The computer device includes at least one processor 801, a communication bus 802, a memory 803, and at least one communication interface 804.

The processor 801 may be a general-purpose central processing unit (CPU), a network processor (NP), or a microprocessor, or may be one or more integrated circuits configured to implement the solutions of this application, for example, an ASIC, a programmable logic device (PLD), or a combination thereof. The PLD may be a complex programmable logic device (CPLD), a field-programmable gate array (FPGA), generic array logic (GAL), or any combination thereof.

The communication bus 802 is used to transmit information between the foregoing components. The communication bus 802 may be classified into an address bus, a data bus, a control bus, or the like. For ease of representation, only one thick line is used to represent the bus in the figure, but this does not mean that there is only one bus or only one type of bus.

The memory 803 may be a ROM, a RAM, an EEPROM, an optical disc (including a compact disc read-only memory (CD-ROM), a compact disc, a laser disc, a digital versatile disc, a Blu-ray disc, or the like), a magnetic disk storage medium or another magnetic storage device, or any other medium that can be configured to carry or store expected program code in a form of instructions or a data structure and that can be accessed by a computer. However, the memory 803 is not limited thereto. The memory 803 may exist independently, and is connected to the processor 801 through the communication bus 802. Alternatively, the memory 803 and the processor 801 may be integrated together.

The communication interface 804 is configured to communicate with another device or a communication network by using any transceiver-type apparatus. The communication interface 804 includes a wired communication interface, or may include a wireless communication interface. The wired communication interface may be, for example, an Ethernet interface. The Ethernet interface may be an optical interface, an electrical interface, or a combination thereof. The wireless communication interface may be a wireless local area network (WLAN) interface, a cellular network communication interface, a combination thereof, or the like.

During specific implementation, in an embodiment, the processor 801 may include one or more CPUs, such as a CPU 0 and a CPU 1 shown in FIG. 8.

In a specific implementation, in an embodiment, the computer device may include a plurality of processors, for example, the processor 801 and a processor 805 shown in FIG. 8. Each of the processors may be a single-core processor, or may be a multi-core processor. The processor herein may be one or more devices, circuits, and/or processing cores configured to process data (for example, computer program instructions).

During specific implementation, in an embodiment, a computer device may further include an output device and an input device. The output device communicates with the processor 801, and may display information in a plurality of manners. For example, the output device may be a liquid crystal display (LCD), a light emitting diode (LED) display device, a cathode ray tube (CRT) display device, or a projector. The input device communicates with the processor 801, and may receive an input from a user in a plurality of manners. For example, the input device may be a mouse, a keyboard, a touchscreen device, a sensor device, or the like.

In some embodiments, the memory 803 is configured to store program code 810 for executing the solutions of this application, and the processor 801 may execute the program code 810 stored in the memory 803. The program code 810 may include one or more software modules. The computer device may implement, by using the processor 801 and the program code 810 in the memory 803, the virtual speaker determining methods provided in embodiments in FIG. 5 and FIG. 6.

All or some of the foregoing embodiments may be implemented by software, hardware, firmware, or any combination thereof. When software is used to implement embodiments, all or a part of embodiments may be implemented in a form of a computer program product. The computer program product includes one or more computer instructions. When the computer instructions are loaded and executed on the computer, the procedure or functions according to embodiments of this application are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid-state drive (SSD)), or the like. It should be noted that the computer-readable storage medium mentioned in embodiments of this application may be a non-volatile storage medium, that is, may be a non-transitory storage medium.

That is, an embodiment of this application further provides a computer-readable storage medium. The computer-readable storage medium stores instructions. When the instructions are run on a computer, the computer is enabled to perform operations of the foregoing virtual speaker determining method.

An embodiment of this application further provides a computer program product including instructions. When the instructions are run on a computer, the computer is enabled to perform operations of the foregoing virtual speaker determining method. In other words, a computer program is provided. When the computer program is run on a computer, the computer is enabled to perform operations of the virtual speaker determining method.

It should be understood that “a plurality of” in this specification means two or more. In descriptions of embodiments of this application, “/” means “or” unless otherwise specified. For example, A/B may indicate A or B. In this specification, “and/or” merely describes an association relationship between associated objects and indicates that three relationships may exist. For example, A and/or B may indicate the following three cases: Only A exists, both A and B exist, and only B exists. In addition, to clearly describe technical solutions in embodiments of this application, terms such as “first” and “second” are used in embodiments of this application to distinguish between same items or similar items that provide basically same functions or purposes. A person skilled in the art may understand that the terms such as “first” and “second” do not limit a quantity or an execution sequence, and the terms such as “first” and “second” do not indicate a definite difference.

It should be noted that information (including but not limited to user equipment information, personal information of a user, and the like), data (including but not limited to data used for analysis, stored data, displayed data, and the like), and signals in embodiments of this application are used under authorization by the user or full authorization by all parties, and capturing, use, and processing of related data need to conform to related laws, regulations, and standards of related countries and regions. For example, the attribute information of the virtual speaker in embodiments of this application is obtained when sufficient authorization is obtained.

The foregoing descriptions are merely embodiments of this application, but are not intended to limit this application. Any modification, equivalent replacement, or improvement made without departing from the principle of this application should fall within the protection scope of this application.

What is claimed is:

1. A virtual speaker determining method, wherein the method comprises:
obtaining attribute information of N first virtual speakers, wherein the N first virtual speakers are virtual speakers that are in a virtual speaker set and that match a higher order ambisonics (HOA) coefficient of a target group of HOA signals, the target group of HOA signals comprises at least one frame of HOA signal, and N is an integer greater than or equal to 1;
obtaining attribute information of N second virtual speakers, wherein the N second virtual speakers are virtual speakers that are in the virtual speaker set and that are configured to process a reference group of HOA signals, and the reference group of HOA signals is at least one group of HOA signals before the target group of HOA signals; and
determining M target virtual speakers based on the attribute information of the N first virtual speakers and the attribute information of the N second virtual speakers, wherein the M target virtual speakers are configured to process the target group of HOA signals, M is an integer greater than 1, and M is greater than N.

2. The method according to claim 1, wherein the attribute information comprises an elevation and an azimuth, and the N first virtual speakers one-to-one correspond to the N second virtual speakers; and
determining the M target virtual speakers based on the attribute information of the N first virtual speakers and the attribute information of the N second virtual speakers comprises:
determining, based on elevations and azimuths of the N first virtual speakers and elevations and azimuths of the N second virtual speakers, distances between the first virtual speakers and the corresponding second virtual speakers, to obtain N distances;
determining M groups of elevations and azimuths based on the N distances; and
determining virtual speakers that are in the virtual speaker set and that correspond to the M groups of elevations and azimuths as the M target virtual speakers.

3. The method according to claim 2, wherein the target group of HOA signals comprises one frame of HOA signal, the one frame of HOA signal comprises H subframes, H is an integer greater than 1, and M is a product of H and N; and
determining the M groups of elevations and azimuths based on the N distances comprises:
using one distance in the N distances as a target distance, and determining, according to the following operation, elevations and azimuths that respectively correspond to the H subframes, until each distance in the N distances is traversed:
when the target distance is greater than a first distance threshold, determining, based on elevations and azimuths of a first virtual speaker and a second virtual speaker that correspond to the target distance, the elevations and the azimuths that respectively correspond to the H subframes.

4. The method according to claim 3, wherein determining, based on the elevations and the azimuths of the first virtual speaker and the second virtual speaker that correspond to the target distance, the elevations and the azimuths that respectively correspond to the H subframes comprises:
determining the elevation and the azimuth of the second virtual speaker that corresponds to the target distance as an elevation and an azimuth that correspond to a first subframe in the H subframes;
determining the elevation and the azimuth of the first virtual speaker that corresponds to the target distance as an elevation and an azimuth that correspond to a last subframe in the H subframes; and
for an i^{th} subframe in the H subframes, determining, through interpolation processing based on an elevation and an azimuth that correspond to an (i−1)th subframe in the H subframes and the elevation and the azimuth that correspond to the last subframe, an elevation and an azimuth that correspond to the i^{th} subframe, wherein i is greater than 0 and less than H−1.

5. The method according to claim 3, wherein the method further comprises:
when the target distance is not greater than the first distance threshold, determining the elevation and the azimuth of the first virtual speaker that corresponds to the target distance as the elevations and the azimuths that respectively correspond to the H subframes; or
when the target distance is not greater than the first distance threshold, determining the elevation and the azimuth of the second virtual speaker that corresponds to the target distance as elevations and azimuths that correspond to first K subframes in the H subframes, and determining the elevation and the azimuth of the first virtual speaker that corresponds to the target distance as elevations and azimuths that correspond to remaining subframes in the H subframes, wherein K is an integer greater than or equal to 1, and K is less than H.

6. The method according to claim 2, wherein the target group of HOA signals comprises P frames of HOA signals, P is an integer greater than 1, and M is a product of P and N; and
determining the M groups of elevations and azimuths based on the N distances comprises:
using one distance in the N distances as a target distance, and determining, according to the following operation, elevations and azimuths that respectively correspond to the P frames of HOA signals, until each distance in the N distances is traversed:
when the target distance is greater than a second distance threshold, determining, based on elevations and azimuths of a first virtual speaker and a second virtual speaker that correspond to the target distance, the elevations and the azimuths that respectively correspond to the P frames of HOA signals.

7. The method according to claim 6, wherein determining, based on the elevations and the azimuths of the first virtual speaker and the second virtual speaker that correspond to the target distance, the elevations and the azimuths that respectively correspond to the P frames of HOA signals comprises:
determining the elevation and the azimuth of the second virtual speaker that corresponds to the target distance as an elevation and an azimuth that correspond to a first frame of HOA signal in the P frames of HOA signals;
determining the elevation and the azimuth of the first virtual speaker that corresponds to the target distance as an elevation and an azimuth that correspond to a last frame of HOA signal in the P frames of HOA signals; and
for a j^{th} frame of HOA signal in the P frames of HOA signals, determining, through interpolation processing based on an elevation and an azimuth that correspond to a (j−1)th frame of HOA signal in the P frames of HOA signals and the elevation and the azimuth that correspond to the last frame of HOA signal, an elevation and an azimuth that correspond to the j^{th} frame of HOA signal, wherein j is greater than 0 and less than P−1.

8. The method according to claim 6, wherein the method further comprises:
when the target distance is not greater than the second distance threshold, determining the elevation and the azimuth of the first virtual speaker that corresponds to the target distance as the elevations and the azimuths that respectively correspond to the P frames of HOA signals; or
when the target distance is not greater than the second distance threshold, determining the elevation and the azimuth of the second virtual speaker that corresponds to the target distance as elevations and azimuths that correspond to first L frames of HOA signals in the P frames of HOA signals, and determining the elevation and the azimuth of the first virtual speaker that corresponds to the target distance as elevations and azimuths that correspond to remaining frames of HOA signals in the P frames of HOA signals, wherein L is an integer greater than or equal to 1, and L is less than P.

9. The method according claim 1, wherein the method is applied to an encoder side device; and
after determining the M target virtual speakers based on the attribute information of the N first virtual speakers and the attribute information of the N second virtual speakers, the method further comprises:
encoding attribute information of the M target virtual speakers into a bitstream; or
encoding an index of a determining manner of the M target virtual speakers into a bitstream.

10. A computer device, wherein the computer device comprises a memory and a processor, the memory is configured to store a computer program, and the processor is configured to execute the computer program stored in the memory, to perform operations comprising:
obtaining attribute information of N first virtual speakers, wherein the N first virtual speakers are virtual speakers that are in a virtual speaker set and that match a higher order ambisonics (HOA) coefficient of a target group of HOA signals, the target group of HOA signals comprises at least one frame of HOA signal, and N is an integer greater than or equal to 1;
obtaining attribute information of N second virtual speakers, wherein the N second virtual speakers are virtual speakers that are in the virtual speaker set and that are configured to process a reference group of HOA signals, and the reference group of HOA signals is at least one group of HOA signals before the target group of HOA signals; and
determining M target virtual speakers based on the attribute information of the N first virtual speakers and the attribute information of the N second virtual speakers, wherein the M target virtual speakers are configured to process the target group of HOA signals, M is an integer greater than 1, and M is greater than N.

11. The computer device according to claim 10, wherein the attribute information comprises an elevation and an azimuth, and the N first virtual speakers one-to-one correspond to the N second virtual speakers; and
determining the M target virtual speakers based on the attribute information of the N first virtual speakers and the attribute information of the N second virtual speakers comprises:
determining, based on elevations and azimuths of the N first virtual speakers and elevations and azimuths of the N second virtual speakers, distances between the first virtual speakers and the corresponding second virtual speakers, to obtain N distances;
determining M groups of elevations and azimuths based on the N distances; and
determining virtual speakers that are in the virtual speaker set and that correspond to the M groups of elevations and azimuths as the M target virtual speakers.

12. The computer device according to claim 11, wherein the target group of HOA signals comprises one frame of HOA signal, the one frame of HOA signal comprises H subframes, H is an integer greater than 1, and M is a product of H and N; and
determining the M groups of elevations and azimuths based on the N distances comprises:
using one distance in the N distances as a target distance, and determining, according to the following operation, elevations and azimuths that respectively correspond to the H subframes, until each distance in the N distances is traversed:
when the target distance is greater than a first distance threshold, determining, based on elevations and azimuths of a first virtual speaker and a second virtual speaker that correspond to the target distance, the elevations and the azimuths that respectively correspond to the H subframes.

13. The computer device according to claim 12, wherein determining, based on the elevations and the azimuths of the first virtual speaker and the second virtual speaker that correspond to the target distance, the elevations and the azimuths that respectively correspond to the H subframes comprises:
determining the elevation and the azimuth of the second virtual speaker that corresponds to the target distance as an elevation and an azimuth that correspond to a first subframe in the H subframes;
determining the elevation and the azimuth of the first virtual speaker that corresponds to the target distance as an elevation and an azimuth that correspond to a last subframe in the H subframes;
and
for an i^{th} subframe in the H subframes, determining, through interpolation processing based on an elevation and an azimuth that correspond to an (i−1)th subframe in the H subframes and the elevation and the azimuth that correspond to the last subframe, an elevation and an azimuth that correspond to the i^{th} subframe, wherein i is greater than 0 and less than H−1.

14. The computer device according to claim 12, wherein the operations further comprise:
when the target distance is not greater than the first distance threshold, determining the elevation and the azimuth of the first virtual speaker that corresponds to the target distance as the elevations and the azimuths that respectively correspond to the H subframes; or
when the target distance is not greater than the first distance threshold, determining the elevation and the azimuth of the second virtual speaker that corresponds to the target distance as elevations and azimuths that correspond to first K subframes in the H subframes, and determining the elevation and the azimuth of the first virtual speaker that corresponds to the target distance as elevations and azimuths that correspond to remaining subframes in the H subframes, wherein K is an integer greater than or equal to 1, and K is less than H.

15. The computer device according to claim 11, wherein the target group of HOA signals comprises P frames of HOA signals, P is an integer greater than 1, and M is a product of P and N; and
determining the M groups of elevations and azimuths based on the N distances comprises:
using one distance in the N distances as a target distance, and determining, according to the following operation, elevations and azimuths that respectively correspond to the P frames of HOA signals, until each distance in the N distances is traversed:
when the target distance is greater than a second distance threshold, determining, based on elevations and azimuths of a first virtual speaker and a second virtual speaker that correspond to the target distance, the elevations and the azimuths that respectively correspond to the P frames of HOA signals.

16. The computer device according to claim 15, wherein determining, based on the elevations and the azimuths of the first virtual speaker and the second virtual speaker that correspond to the target distance, the elevations and the azimuths that respectively correspond to the P frames of HOA signals comprises:
determining the elevation and the azimuth of the second virtual speaker that corresponds to the target distance as an elevation and an azimuth that correspond to a first frame of HOA signal in the P frames of HOA signals;
determining the elevation and the azimuth of the first virtual speaker that corresponds to the target distance as an elevation and an azimuth that correspond to a last frame of HOA signal in the P frames of HOA signals; and
for a j^{th} frame of HOA signal in the P frames of HOA signals, determining, through interpolation processing based on an elevation and an azimuth that correspond to a (j−1)th frame of HOA signal in the P frames of HOA signals and the elevation and the azimuth that correspond to the last frame of HOA signal, an elevation and an azimuth that correspond to the j^{th} frame of HOA signal, wherein j is greater than 0 and less than P−1.

17. The computer device according to claim 15, wherein the operations further comprise:
when the target distance is not greater than the second distance threshold, determining the elevation and the azimuth of the first virtual speaker that corresponds to the target distance as the elevations and the azimuths that respectively correspond to the P frames of HOA signals; or
when the target distance is not greater than the second distance threshold, determining the elevation and the azimuth of the second virtual speaker that corresponds to the target distance as elevations and azimuths that correspond to first L frames of HOA signals in the P frames of HOA signals, and determining the elevation and the azimuth of the first virtual speaker that corresponds to the target distance as elevations and azimuths that correspond to remaining frames of HOA signals in the P frames of HOA signals, wherein Lis an integer greater than or equal to 1, and Lis less than P.

18. The computer device according to claim 10, wherein the computer device comprises an audio encoder or an audio decoder.

19. A non-transitory computer-readable storage medium, wherein the storage medium stores instructions, and when the instructions are run on a computer, the computer is enabled to perform operations comprising:
obtaining attribute information of N first virtual speakers, wherein the N first virtual speakers are virtual speakers that are in a virtual speaker set and that match a higher order ambisonics (HOA) coefficient of a target group of HOA signals, the target group of HOA signals comprises at least one frame of HOA signal, and N is an integer greater than or equal to 1;
obtaining attribute information of N second virtual speakers, wherein the N second virtual speakers are virtual speakers that are in the virtual speaker set and that are configured to process a reference group of HOA signals, and the reference group of HOA signals is at least one group of HOA signals before the target group of HOA signals; and
determining M target virtual speakers based on the attribute information of the N first virtual speakers and the attribute information of the N second virtual speakers, wherein the M target virtual speakers are configured to process the target group of HOA signals, M is an integer greater than 1, and M is greater than N.

20. A non-transitory computer-readable storage medium according to claim 19, wherein the attribute information comprises an elevation and an azimuth, and the N first virtual speakers one-to-one correspond to the N second virtual speakers; and
determining the M target virtual speakers based on the attribute information of the N first virtual speakers and the attribute information of the N second virtual speakers comprises:
determining, based on elevations and azimuths of the N first virtual speakers and elevations and azimuths of the N second virtual speakers, distances between the first virtual speakers and the corresponding second virtual speakers, to obtain N distances;
determining M groups of elevations and azimuths based on the N distances; and
determining virtual speakers that are in the virtual speaker set and that correspond to the M groups of elevations and azimuths as the M target virtual speakers.
